(19) United States
(12) Patent Application Publication
(10) Pub. No.: US 2008/0134724 A1
(43) Pub. Date: Jun. 12, 2008

(54) GLASS CONTAINER FORMING CONTROLLER

(76) Inventors: Randall L. Soultz, Jonesboro, IN (US); Dan Friday, Marion, IN (US); Mark Hoyt, Muncie, IN (US); Greg Young, Marion, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/937,331

(22) Filed: Nov. 8, 2007

Related U.S. Application Data
(60) Provisional application No. 60/864,889, filed on Nov. 8, 2006.

(51) Int. Cl. G06F 13/00; H01H 43/00

(52) U.S. Cl. 65/158; 65/160

(57) ABSTRACT

A software and hardware system is described for forming glass containers. Terminal programs are executed to display a variety of menus and configuration options for operator selection and adjustment, enabling an operator to adjust timing of various steps in the container formation process. In some situations the operator views graphical images of the relative timing of bottles appearing at the machine output and the window of time in which the bottle is expected to appear. A hot-end ware reject subsystem combines a photo-eye, a blow-off solenoid, and configuration switches with a software executable to automate the rejection process for improperly formed containers, such as those that are broken, lying on the conveyor, stuck to a neighbor, and the like.

### REFERENCE TO RELATED APPLICATION

This application claims priority to U.S. Provisional Patent Application 60/864,889, “Glass Container Forming Controller,” filed Nov. 8, 2006, which is hereby incorporated by reference as if fully set forth herein.

### FIELD

The present invention relates to manufacturing and associated control systems. More specifically, the present invention relates to controller-implemented systems for managing and operating automated equipment for the manufacturer of glass containers.

### BRIEF DESCRIPTION OF THE DRAWINGS

FIG. 1 is a systematic diagram of a control system according to one embodiment of the present system.

FIG. 2 is a block diagram of modules in a controller rack for use in the embodiment of FIG. 1.

FIG. 3 is an elevation view of an Individual Section Machine for use with the embodiment of FIG. 1.

FIG. 4 is a plan view of a conveyor and transfer system for use with the embodiment of FIG. 1.

FIG. 5 is a top view of a “pusher” in three alternative positions according to the embodiment of FIG. 1.

FIG. 6 is a schematic diagram of a feeder mechanism for a 10-section glass container forming machine for use with the embodiment of FIG. 1.

FIG. 7 is a timing diagram showing certain signals for a tandem-machine embodiment according to FIG. 1.

FIG. 8 is a screen shot of the main menu of a job editor interface according to one embodiment of the disclosed system.

FIG. 9 is a screen shot of a job selection dialog according to one embodiment of the disclosed system.

FIG. 10 is a screen shot of an “edit job” screen.

FIG. 11 is a screen shot of an “edit job configuration” interface.

FIG. 12 is a screen shot of an auxiliary program configuration interface.

FIG. 13 is a screen shot is a group events configuration interface.

FIG. 14 is a screen shot of a section angles configuration interface.

FIG. 15 is a screen shot of timing screen for section event timing.

FIG. 16 is a screen shot of a main menu for an operator interface.

FIG. 17 is a screen shot of an event timing interface.

FIG. 18 is a screen shot of a “degree change” interface for modifying directly the On/Off degree values for an event.

FIG. 19 is a screen shot of a section selection interface.

FIG. 20 is a screen shot of a section selection interface for a “fill event” operation.

FIG. 21 is a screen shot of another section selection interface for a “fill event” operation.

FIG. 22 is a screen shot of an event group selection dialog.

FIG. 23 is a screen shot of an interface for managing event groups.

FIG. 24 is a screen shot of an auxiliary cycle selection interface.

FIG. 25 is a screen shot of an auxiliary cycle management interface.

FIG. 26 is a screen shot of an interface for modifying angular differentials between machines and machine sections.

FIG. 27 is a screen shot of a dialog box for direct entry of a new differential angle in connection with the interface of FIG. 26.

FIG. 28 is a screen shot of a dialog box for direct entry of a new section angle in connection with the interface of FIG. 26.

FIG. 29 is a screen shot of a job data loading and saving interface.

FIG. 30 is a screen shot of a dialog for selecting a job data file to open.

FIG. 31 is a screen shot of a job saving dialog.

FIG. 32 is a screen shot of a section output status display

FIG. 33 is a screen shot of a status screen for the DeviceNET network.

FIG. 34 is a screen shot of a section remote control interface.

FIG. 35 is a screen shot of an alarm status screen.

FIG. 36 is a screen shot of a shop status display/interface.

FIG. 37 is a screen shot of a run statistics interface.

FIG. 38 is a screen shot of an interface for viewing and manipulating parameters for operation of the Hot End Ware Reject (HEWR) section.

FIG. 39 is a screen shot of a HEWR trend display and control interface.

FIG. 40(A-E) are timing diagrams illustrating relative positions of cavity and zone timing windows and gob presence signals.

FIG. 41 is a screen shot of a system status display.

FIG. 42 is a screen shot of an exit confirmation dialog.

FIG. 43 is a flowchart showing the overall process flow for a machine section.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

Generally, one form of the present invention is a software and hardware system that controls manufacturing equipment to produce bottles made of glass on two container forming machines connected together, such that production settings on one of the container forming machines can be changed without interrupting production on the other container forming machine. In another embodiment, the control system leverages off-the-shelf PLC components to precisely schedule output images based on calculated output image times, distributing those output image update times via a fiber optic data network. In other embodiments, the manufacturing equipment produces other products as will occur to those skilled in the art.

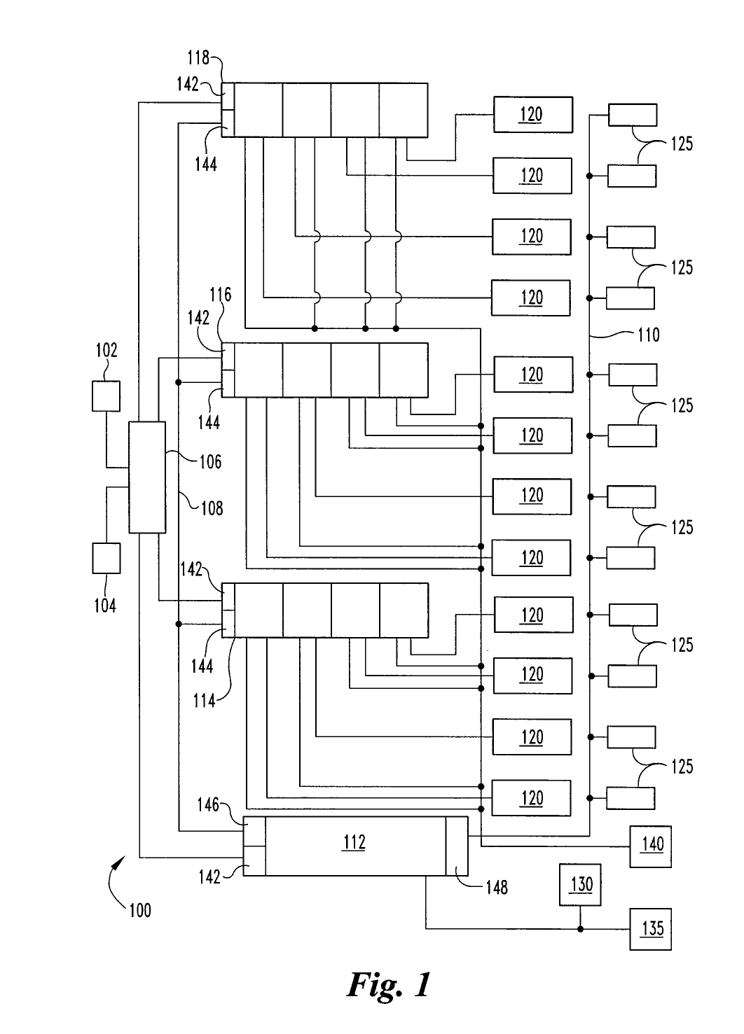

As shown in FIG. 1, control system 100 includes control room terminal 102, for operator interface computer 104, network hardware 106, high-speed communication network 108, DeviceNET network 110, controller racks 112, 114, 116 and 118, solenoid valve blocks 120, operator panels 125, HEWR system 130, drive system 135, and pressure system 140. The embodiment illustrated herein will be described in terms of the components, and they will be described in more detail herein, but other implementations of the system will include more, fewer, and/or different components and communication systems as will occur to those skilled in the art.

### Control Room Terminal

Control room terminal 102 resides in a control room of the manufacturing facility and is used for creating, modifying, copying, and deleting job data. The job data is stored on the hard disk of control room terminal 102 in data tables they database, such as a MICROSOFT ACCESS database, and it includes the function timing for all production sections in terms of “degrees” (as will be discussed further herein) for “ON” and “OFF” states. The job data also includes information regarding the configuration of the system and other parameters specific to the particular job. The job data is accessed via the “Eclipse Job Editor,” which is described further herein, and which in this embodiment is developed using VISUAL BASIC for WINDOWS.

### Operator Interface Computer

Operator interface computer 104 is typically located on the plant floor near the production machine. It communicates with the control room terminal 102 and the PLC's (programmable logic controllers) in the system via network hardware 106. In one embodiment, the PLC's are Allen-Bradley PLC's, and network hardware 106 comprises an Ethernet LAN. The operator interface computer 104 executes an operator interface program, which is a combination of RSVIEW software by Rockwell and custom programming in Visual Basic. RSVIEW is a development package that communicates with Allen-Bradley PLC's and provides tools for developing reference-based screens for interacting with the PLC's. The operator interface computer provides the following functionality:
Display the job data that is loaded into the PLC's.
Provide screens for making changes to that data.
Provide job download and job save screens.
Record and display changes to the data to log files and screens.
Provide diagnostic screens.
Record and display system alarms to log files and screens.
Print the log files.
Manage user logons and authority levels for interaction with PLC data.
Manage the download process of data from the control room terminal to the PLC's.
Monitor system performance and log the information for display or printing.

### Local Area Network

In this illustrated embodiment, an Ethernet network 106 enables communication between the control room terminal 102 and the operator interface computer 104. Network 106 also provides a high-speed communications path between all of the PLC processors located in the controller racks 112, 114, 116, and 118 via the Allen-Bradley E-NET modules 142 in each rack 114, 116, 118 (and, in some embodiments, rack 112 as well). The operator interface computer 104 also communicates to these processors by using network 106 for downloading and production data changes.

### High Speed Connection Network

High speed connection network 108 is preferably a SYNCHLINK network, which provides a very high-speed fiber-optic communications path between all of the PLC processors located in the controller racks 112, 116, and 118 via Allen-Bradley SYNCHLINK modules 144 located in each rack. The SYNCHLINK module 146 in main controller rack 112 is the time master, coordinating the system clock for each processor, thereby ensuring that each processor is synchronized on a standard time base. In the present embodiment, the synchronization achieves one picosecond accuracy. Time master 146 also continuously sends buffered data (including the next 8 output image execution times, based upon the current production rate) to each processor through its respective SYNCHLINK module 144.

### DeviceNET Network

DeviceNET network 110 provides a high-speed communications path between all of the operator panels 125 and the DeviceNET module 148 located in the main controller rack 112. Each operator panel 125 in the system 100 has a DeviceNET Interface Board (not shown) connected to the Push Buttons, Switches, Indicator Lights and a +24 VDC Source Voltage. It is through this board that DeviceNET 110 detects the operation of the buttons and switches, and lights the indicator lights on each operator panel 125 when commanded to do so.

### Controller Racks

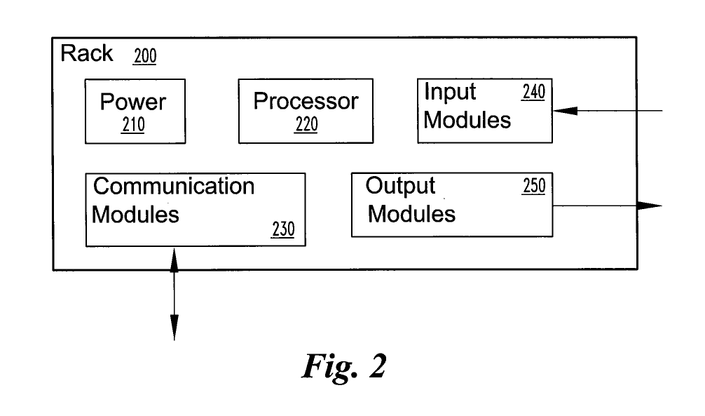

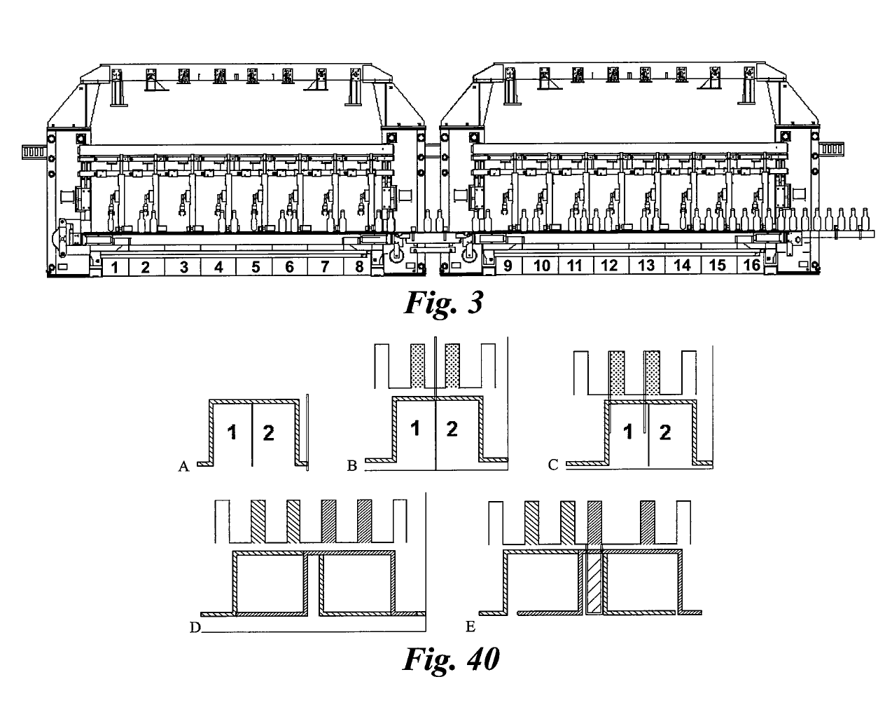

Controller racks 112, 114, 116, and 118 are each built upon an Allen-Bradley CONTROLLOGIX chassis, which provides slots and a backplane for interconnecting various modules. In the present embodiment, as illustrated in FIG. 2, a rack 200 (representing, in its various forms, racks 112, 114, 116, and 118) includes an installed CONTROLLOGIX power supply 210, one or more processors 220, various communication modules 230, discrete input modules 240, and discrete output modules 250.

### Main Controller Rack

The main controller rack 112 in the illustrated embodiment includes three CONTROLLOGIX 5561 processors programmed to act as a main processor, array processor, and HEWR (Hot End Ware Reject) processor, respectively. The main processor performs synchronization and timing calculations. It also calculates the output image execution times that are broadcast to the section controllers via the high speed communications network 108. The array processor receives job data from operator interface computer 104 and converts it from “ON” and “OFF” degree timing into a binary image for each of the outputs for each section of the system 100. These binary images are then sent to the appropriate section controller processors. The HEWR processor monitors the requests for rejecting bottles (to be blown off by a solenoid) from the section's reject switches, monitors the position of each section's bottle(s), and controls the sequencing of the reject process.

Main controller rack 112 also houses two CONTROLLOGIX E-net Ethernet modules. One is used for processor to processor communications, and the other communicate with the operator interface computer 104. A CONTROLLOGIX SYNCHLINK module is used for the master clock and transmitting buffered data to the other processors. A CONTROLLOGIX DeviceNET module interfaces with the push buttons and indicator lights located on each section's operator panel 125. CONTROLLOGIX input modules are used to detect the HEWR Photo-Eye (see below) and synchronization pulses from the drive system 135. CONTROLLOGIX output modules are used to energize the HEWR blow-off solenoid, and provide synchronization pulses to the drive system 135. Some of the outputs in this rack are also sent to the drive system 135 to indicate production counts for production data acquisition.

### Section Controller Racks

Each of the section controller racks 114, 116, and 118 controls four of the I.S. machine's sections' outputs for operating the container-forming mechanisms. A 20-section Eclipse E-Timing control system would contain five of these section racks. In this illustrated embodiment, each section controller rack 114, 116, or 118 includes a CONTROLLOGIX 5561 processor, known as the Section Processor. The processor is programmed to allow it to perform its section timing functions. The program is common across all of the section controllers, but each instance does identify itself through these discrete inputs, which are energized in a specific pattern for rack number identification.

The section processor performs synchronization and timing calculations. It also schedules the output image execution times that are received from the processor on the Main Controller rack 112 via the SYNCHLINK modules 144. In addition to scheduling the output execution times, this processor also manages the incrementing of a pointer to a row in an array Binary Output Images. This element of the array becomes the output image that is sent to the output modules for execution at the scheduled times.

Each Section Processor continually receives status information from the Main Processor so that it can stop one or more production section(s) if a fault is detected. In addition, these processors send their status to the Main Processor so that it can react accordingly if a fault is detected in the Section Controller Rack.

The Main Processor also reacts to Push Button status data from the operator panels 125 through the DeviceNET module 148 located in the Main Controller rack 112. As Push Buttons are activated/deactivated, the status of each is stored in the DeviceNET module 148. The Main Processor continuously scans this data and broadcasts it to the Section Processors so that the appropriate section can respond to Push Buttons and Switch activity that is pertinent to it (e.g., “Section Start,” “Program Stop,” “Auxiliary Cycles,” and “Container Reject Requests”).

A CONTROLLOGIX E-Net Ethernet module communicates with the main controller's processor. A CONTROLLOGIX SYNCHLINK module receives master clock data and buffered data from the Main Processor. A CONTROLLOGIX's input module detects the condition of the “maintenance stop” hardwired circuit and uniquely identifies the section rack.

Each section rack in this embodiment also includes 12 CONTROLLOGIX output modules, which energize the solenoid valves on the machine and standalone controllers such as pusher systems 140 and gob distributors. Each section uses three of these 16-point output modules, providing a total of 48 outputs per section. These modules have the ability to schedule output images to occur at a specific time. The Eclipse E-Timing Control System takes advantage of this capability to provide accurate function timing. The control system 100 takes advantage of this capability to provide accurate function timing.

### Solenoid Valve Blocks

Each section has a solenoid valve 20 with a valve block cover that connects the outputs of a controller rack's output modules to the solenoids on the production machine.

### Operator Panels (Pushbuttons and Lights)

Each section on the machine has two operator panels 125 that contain the pushbuttons and lights necessary for control of the section. One of these panels is on the front side of the machine, with the other located on the back side of the machine. Each operator panel 125 has a DeviceNET Interface Board connected to the Push Buttons, Switches, Indicator Lights and a +24 VDC Source Voltage. It is through this board that the DeviceNET 110 detects the operation of the buttons and switches, and lights the indicator lights when commanded to do so.

### HEWR System (Hot Bottle Blow-Off/Reject)

The HEWR system 130 is a combination of a photo-eye, which detects the presence of bottles at a blow-off solenoid, the blow-off solenoid, and the Reject switches on the operator panels 125. The system 100 calculates the position of each section's bottles as they travel down the conveyor to insure that the correct bottles are blown off when a reject request is received.

### Drive System

The drive system 135 and the E-Timing system should be precisely synchronized. The E-Timing control system also sends timed Interceptor signals to the drive system 135 so that the glass can be distributed to the appropriate sections at the proper time.

### Pusher System

The pusher system 140 reacts to “pushout” timing signals from the E-Timing control system so that the containers can be pushed out onto the Main conveyor at the appropriate time.

Glass Container Forming with E-Timing Systems

E-Timing Systems control the movement of mechanisms and cooling functions used to form glass containers. The mechanisms are typically actuated by means of an electronic solenoid valve, which in turn provides pilot air to a larger cylinder that physically moves the mechanism. Other mechanisms are based upon servomotors and have their own separate control systems. The E-Timing System provides “trigger pulses” to these servo systems at the appropriate time for the servomechanism to execute its pre-programmed motion profile.

Glass container forming machines are referred to as I.S. (Individual Section) Machines. An I.S. Machine contains between 8 and 20 duplicate stations, referred to as Sections. Each Section has its own set of moulds and forming equipment for producing between 1 and 4 containers during each cycle.

The sequence in which the mechanisms actuate, and the amount of time that they remain actuated, are determined by the forming process for that particular container type. Each section's sequence begins with the delivery of molten glass cylinders, referred to as “Gobs,” to the back side of the section and into the Blank Moulds. Other mechanisms on the “Blank” side are actuated to assist in the forming of a preliminary container called a parison. When the Blank side forming steps are completed, the parisons are transferred to the front side of the machine where they are positioned inside the final moulds. Here again other mechanisms on the “Mould” side are actuated to assist in the forming of the finished container. The containers are then mechanically taken out of the moulds and positioned onto a cooling plate. Then they are pushed out in a rotary motion onto a common conveyor. Immediately after the parisons are transferred to the mould side of the machine, a new set of gobs is delivered to the blank side, continuously repeating the sequence until commanded to stop. In alternative embodiments, other methods of material handling are implemented will occur to those skilled in the art.

In some embodiments, the system that delivers the glass gobs to the sections can only deliver to one section at a time. The time that it takes for a gob distributor to deliver gobs to all of its associated sections is the same amount of time that each section takes to complete a forming cycle. The synchronization between the gob distributor and the I.S. machine is controlled by the interaction of signals between the Gob Distributor Drive Control System 135 and the E-Timing System. The Gob Distributor is capable of delivering the glass to the sections in a patterned sequence called the “Firing Order.”

The Firing Order is determined by a few process requirements and parameters. One is the desired distance between the bottles on the main conveyor.

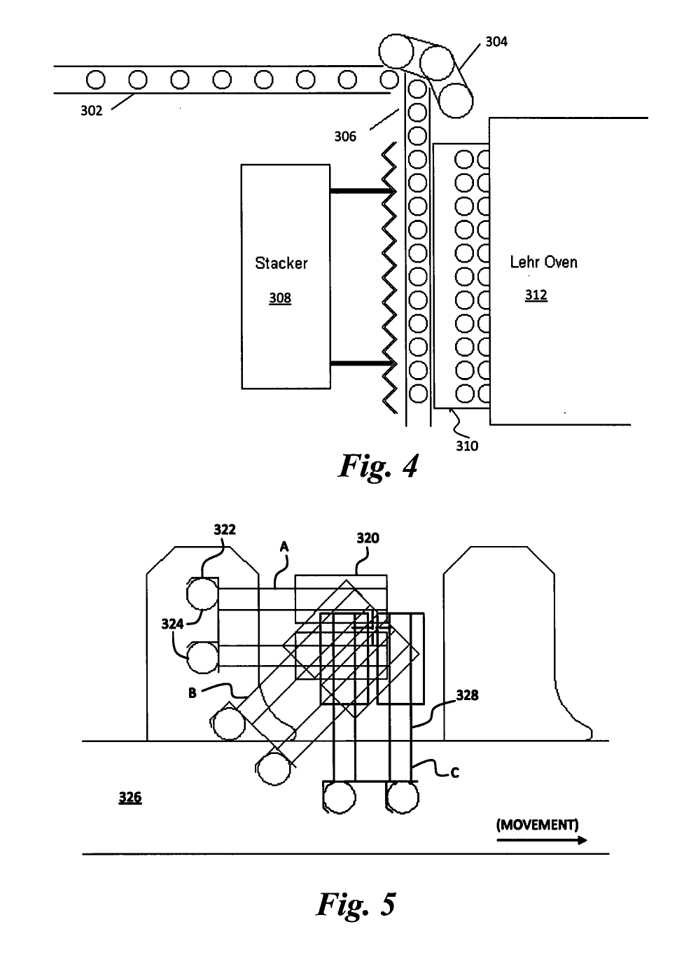

The spacing of the containers on the conveyor, referred to as the “Ware Spacing,” is often important in the glass forming process. As illustrated in FIG. 4, the containers travel down the main conveyor 302 to a right-angle transfer system 304, which consists of a rotating belt with paddles that move the containers at a right angle onto a cross conveyor 306. The containers are then pushed by a “Stacker” machine 308 onto a wide belt 310 that travels through an annealing lehr oven 312 that strengthens the bottles by tempering them with heat.

The space between the containers on the main conveyor is achieved by the combination of belt speed, pusher finger spacing and the timing of when they are pushed onto the conveyor. As shown in FIG. 5, pusher fingers 322 at the end of the arms of pusher apparatus 320 engage bottles 324. Assembly 320 rotates from position A through position B to position C, whereupon bottles 324 have been moved to belt 326. While belt 326 goes to the right (relative to the view shown in FIG. 5), thereby carrying bottles 324 away from pusher assembly 320, pusher legs 328 retracts towards the axis of rotation before re-extending to engage new bottles 324 in a subsequent cycle.

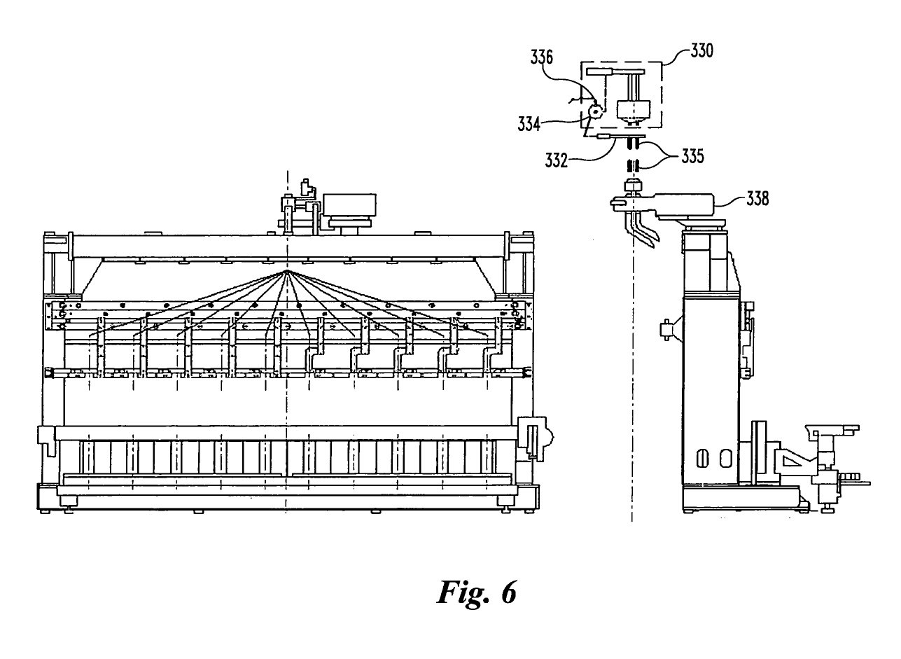

Turning to FIG. 6, the starting point of a given section is determined by its synchronization with the gob distributor 338. When the gob distributor 338 is in position to deliver the gobs to a section, the section's mechanisms must be in the position to accept the gobs. The gob distributor 338 has a proximity switch that detects one complete revolution of the gob distributor. The digital pulses created by the gob proximity switch are referred to as gob prox pulses.

The feeder mechanism 330 creates the gobs 335 by extruding the glass into cylinders that are then cut by a set of shears 332. The shears 332 are typically actuated by a cam 334 on the feeder mechanism 330. Each time the mechanism 330 feeder extrudes a new set of gobs, a notch in the cam is detected by a proximity switch 336. The digital pulses created by the feeder proximity switch 336 are referred to as feeder prox pulses. For example, on a 10-section machine, a machine cycle consists of 10 Feeder Prox Pulses and one Gob Pulse.

The machine cycle is always 360 degrees. In a 10-section machine there are 36 degrees between sections.

The section base angles (the number of degrees between the gob pulse and the starting point of a particular section) determine the firing order. For example, for a firing order of 1-3-5-7-6-2-4-8-9-10, the Section Base Angles for sections 1-10 would be 0-180-36-216-72-144-108-252-288-324, respectively. Each section starts its cycle when its base angle occurs in the machine cycle. Since the machine cycle and section cycle are equal in time, when the section cycle completes (360°) it is time to start again.

Each section has up to 48 functions (mechanisms and cooling). The function timing is set by entering its ON degrees and OFF degrees. Once a section has its functions properly timed, the timing can be copied to the remaining sections.

Since we are timing off of the Feeder Prox. Pulse (or a precise synthetic pulse generated by some drive systems), which is at regular intervals, and the gob takes longer to travel to the outer sections' blank molds after delivery, each section has a “Base Angle Offset” parameter, which is added to the section angle. This allows the setup personnel to work with section angles in even 36-degree increments and to maintain consistent function timing for each section.

The control of the speed of these 48 functions per section is accomplished by utilizing a virtual timing drum. The “ON” time and “OFF” time of each function is entered in degrees (0-360). This allows the production rate to vary for a production run without having to retime the sections functions. As the production rate increases the time represented by a degree decreases, but the timing in degrees remains the same.

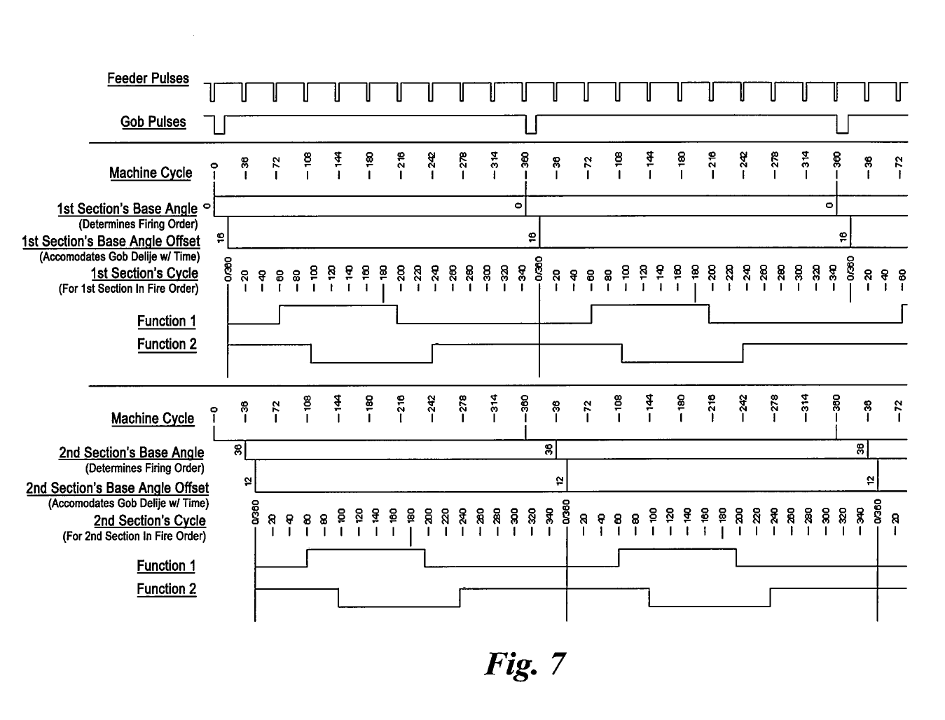

Refer to FIG. 7 for examples of function timing and how it is affected by the Section Base Angle and Section Base Angle Offset values.

### Overall Flow

The overall flow of a machine section is shown in the flowchart in FIG. 43. This operation is further explained by the text and other figures herein.

The “Job Editor” program typically resides on control room computer 102 (see FIG. 1). It is used to create and modify Job Files for downloading to the Eclipse Controller via software on the Operator Interface computer 104.

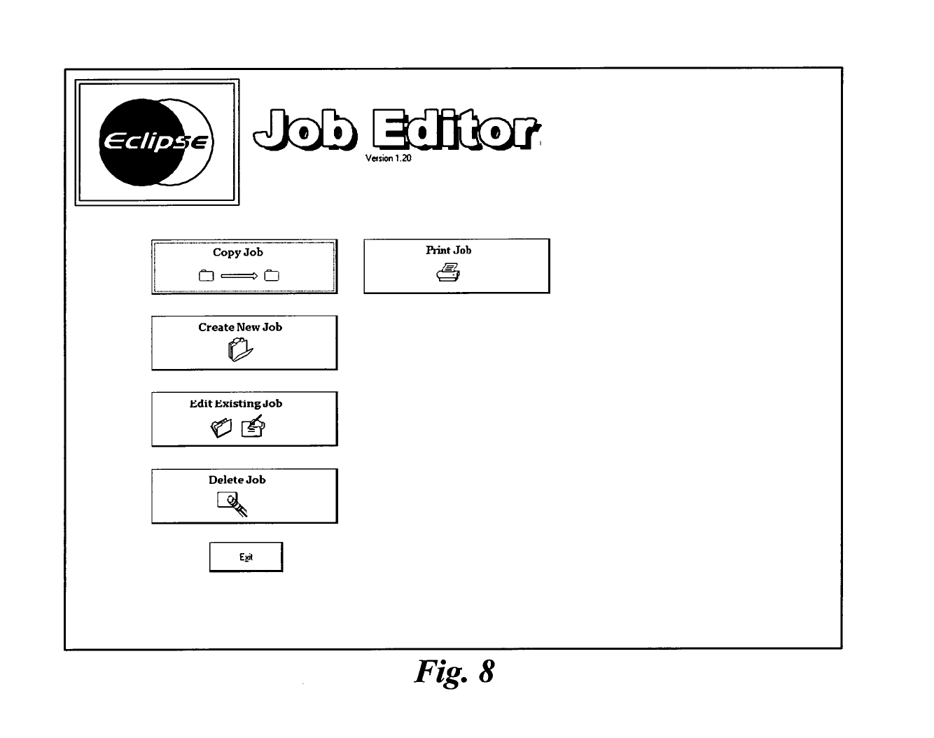

As illustrated in FIG. 8, the Main Menu is used to move among the various screens/displays used in the Eclipse Job Editor program. It contains “Command Buttons” that when activated display the associated screen(s). A thin, black, dashed line forming a rectangle inside the border of the button indicates the currently selected “Command Button.” Any object with this border is referred to as having the “Focus.” This Focus rectangle is used throughout the Eclipse Job Editor application and indicates an object that causes an action when the “ENTER” key is pressed.

One may press the “TAB” key until the focus is positioned on the “Command Button” that you want, and then press the “ENTER” key to execute the associated action. In FIG. 8, the “Focus” is on the “Copy Job” common button. Pressing “ENTER” displays an Event Timing Screen.

Using a Mouse

In addition to using the keys as described above, the present embodiment allows any object to be selected/executed by positioning the mouse cursor on the object, then clicking the left mouse button.

Command Buttons

The Main Menu, as illustrated in FIG. 8, displays command buttons that a user can activate to copy a job file, create a new job, edit an existing job, delete a job from storage, or print a job. Each of these objects will be discussed in turn.

The “copy job” option allows copying an existing job to a new job file. It can create the copy to be used on either the same or the other half of the tandem machine. With this, four different copy options are available:
Copy a job from machine “A” to machine “A,”
Copy a job from machine “A” to machine “B,”
Copy a job from machine “B” to machine “B,” and
Copy a job from machine “B” to machine “A.”

When one edits an existing job, the settings and/or program of the job are modified using the user interface as described below, and changes may be saved in the job file. In some embodiments, the “edit existing job” command button yields an interface with an option to save the modified file under a new job name, while in others the user must copy a job file to a new name, then edit it in order to achieve the same result.

The “print job” command button prints the job summary data and event timing for a selected job. The “delete job” command button permanently deletes all data associated with the selected job.

### Select Job Dialog

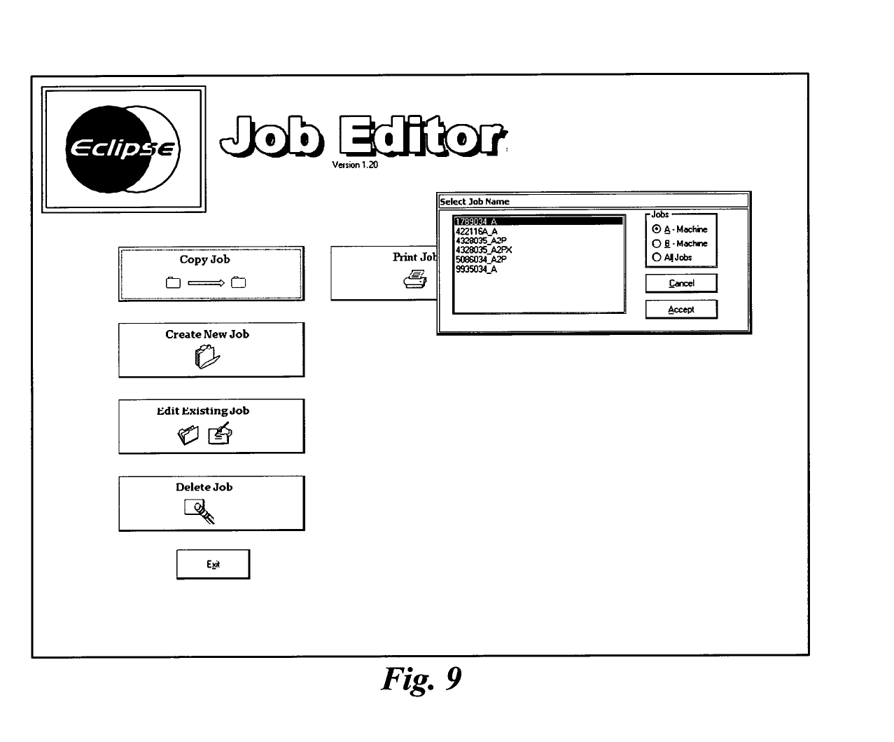

When any of the Command Buttons are activated, the first step is to select the primary Job for the selected operation. This is accomplished by selecting the desired Job Name from the “Select Job Name” dialog box as shown in FIG. 9.

The dialog box defaults to listing Job Names for “A” Machine Jobs. This can be changed to display only “B” Machine Jobs, or “All” Jobs by clicking the appropriate “Jobs” option button from the group. If there are more Job Names than can be displayed in the available list, a vertical scroll bar will appear that allows scrolling down through the list. The user can click on the desired Job Name then click the “Accept” button to continue, or click the “Cancel” button to cancel the operation.

### Edit Existing Job Screen

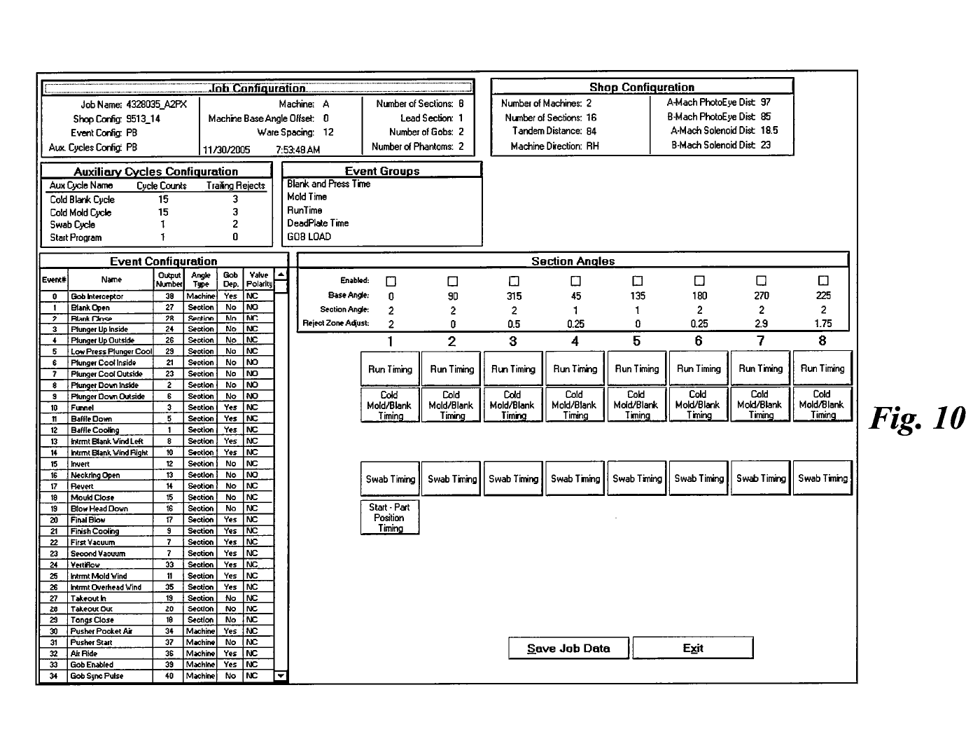

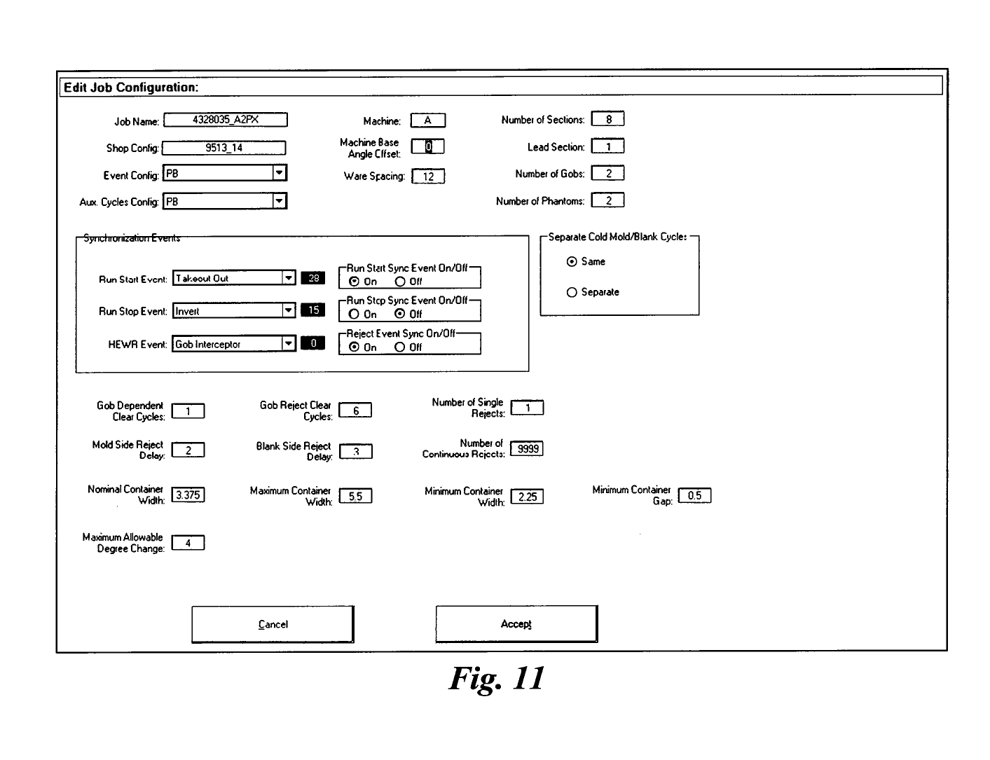

In response to selection of the “edit existing job” command button in the main menu (FIG. 8), an interface screen as illustrated in FIG. 10 is presented summarizing information in several areas, and enabling modification of certain items relating to job configuration, shop configuration, auxiliary cycles configuration, event groups, event configuration, section angles, event timing cycles, and save job data command button. With each of these configuration groups there is an associated command button located above the group. When one of these command buttons is selected, the software displays an appropriate configuration screen. Each screen is discussed on the following pages. Once a configuration has been modified, the changes may be saved by selecting the “Save Job Data” command button on this screen. If the “Exit” button is selected on this screen without saving first, any modifications will be discarded.

### Edit Job Configuration Screen

The “edit job configuration” screen illustrated in FIG. 11 displays the job configuration parameters for the selected job and allows them to be modified. The information entered here is stored in the Job Configuration table of the Microsoft Access database file that stores all of the job information. The fields on this screen include job name, shop configuration, event configuration, auxiliary cycles configuration, machine selector, machine base angle offset, ware spacing, number of sections, lead section, number of gobs, number of phantoms, synchronization events, run start event, run stop event, HEWR event, separate cold mold/blank cycles, gob dependent clear cycles, gob reject clear cycles, number of single rejects, number of continuous rejects, mold side reject delay, blank side reject delay, nominal container width, maximum container width, minimum container width, minimum container gap, maximum allowable degree change, and cancel and accept command buttons.

The job name field displays the job name previously assigned to the job. Similarly, the shop configuration field displays the shop configuration identifier previously assigned to the job. These entries cannot be modified here.

The event configuration field displays the event configuration code previously assigned to the job. This entry can be modified here by selecting another event configuration from the drop-down list presented. If the event configuration selection is changed, the present embodiment does not update the remaining values on the screen, though in other embodiments the screen will be automatically updated. In the former type of embodiment, after changing the event configuration file, the user should accept the change to leave this screen, then return to it using the “editing system job” command button on the main menu. This will refresh the event list for the synchronization events to reflect the new event configuration.

In this embodiment, if the Event Configuration is changed, the following files associated with a job will need to be modified: Auxiliary Cycles Configuration, Event Groups, Run Timing, Auxiliary Cycle Timing, and Start Cycle Timing. The reason is that all of these files reference events by the event number, which may not relate to the same mechanism after changing to a different Event Configuration File.

The auxiliary cycles configuration field displays the auxiliary configuration previously assigned to the job. This entry can be modified here by selecting another auxiliary configuration from the drop-down list. As with the event configuration selection, if the auxiliary configuration is changed, the following files associated with the job will need to be modified: Auxiliary Cycles Configuration, Auxiliary Cycle Timing, and Start Cycle Timing.

The machine field displays the tandem machine half (A or B) previously assigned to the job.

The machine base angle offset field displays the machine base angle offset in degrees for the tandem machine half previously assigned to the job. This entry can be changed here by entering a value between 0-359.5 degrees. Typically, “A” machine jobs will have a base angle offset of zero degrees.

The ware spacing field displays the ware spacing in inches between the two sections' wares. In this embodiment, this entry can be changed here by entering a value between 0-21 inches.

The number of sections field displays the total number of sections used for the job. For example, on a 16-section machine running reduced sections (by dropping two sections), the “number of sections” field might be set to 14. In this embodiment, this entry can be changed here on the “edit job configuration” screen by entering a value between 1-20 sections.

The lead section field displays the lowest numbered section used for the job. For example, on a 16-section machine running with reduced sections (by dropping two sections), the program might drop section #1 on the “A” machine, so the “lead section” field would be set to 2. If the drop section is section #9 on the “B” machine, the lead section setting would be 10. This entry can be changed here by entering a new value between 1-20.

The number of gobs field displays the number of gobs delivered to each section in this job. This entry can be changed here by entering a value between 1-4 gobs.

The “number of phantoms” field displays the number of phantom pockets created on the conveyor for this job. This entry in this embodiment can be changed here by entering a value between 0-4 phantom pockets.

The “synchronization events” group allows the user to select the “trigger” events for starting and concluding auxiliary cycles and HEWR. Selecting from the event name drop-down list automatically fills in the associated event number. The user can then select whether the “ON” or “OFF” degree of this event is to be used as the trigger.

The “run start event” selection and On/Off degree selection establish which event is used to determine the starting point of a normal run cycle. Typically, this synchronization event is set to the “TakeOut-OUT” and “ON” degree.

The “run stop event” and On/Off degree selection establish which event should be used to determine the stopping point of a normal run cycle. Typically this Synchronization Event is set to the “Invert” and “OFF” degree.

The HEWR event selection and On/Off degree selection establish which event should be used to determine the starting point of a “hot end ware reject” cycle. Typically this Synchronization Event is set to the “Gob Interceptor” and “ON” degree.

The “separate cold mold/blank cycles” entry determines whether the blue buttons on the mold side and blank side operator panels 125 (see FIG. 1) run separate auxiliary cycle program or the same auxiliary cycle program. Typically this entry is set to “same”.

The “gob-dependent clear cycles” field displays the total number of cycles that should elapse before canceling the dependent events. The purpose of this field is to allow gob-dependent events to continue until all gobs have cycled out of the blanks and molds before ignoring them. This entry can be changed here by entering a value between 1-2 cycles.

The “gob reject clear cycles” field displays the total number of cycles to should elapse before canceling hot end ware reject for a section after gob delivery has been cancelled. This entry can be changed here by entering a value between 1-12 cycles.

The “number of single rejects” field displays the number of cycles for a specific container to be blown off when a “single reject” switch has been activated. This entry can be changed here by entering a value between 1-9999 containers.

The “mold side reject delay” field determines the number of cycles to delay before rejecting ware after a “mold side reject” switch has been activated. This entry can be changed here by entering a value between 1-12 cycles.

The “blank-side reject delay” determines the number of cycles to delay before rejecting ware after a blank side reject switch has been activated. This entry can be changed here by entering a value between 1-12 cycles.

The “nominal container width” field displays the standard average width in inches of the container running on this half of the tandem machine. This parameter is used in conjunction with the hot end ware reject parameter, and can be changed here by entering a value between 0.5-21 inches.

The “maximum container width” displays the maximum width in inches of the container running on this half of the tandem machine before it is considered to be a “down or stuck” container. Any container wider than this will be blown off. This entry can be changed here by entering a value between 0.5-21 inches.

The “minimum container width” field displays the minimum width in inches of the container running on this half of the tandem machine before it can be considered to be a broken container (glass shard). Any container narrower than this will be blown off. This entry can be changed here by entering a value between 0.5-21 inches.

The “minimum container gap” field displays the minimum gap in inches between containers running on this half of the tandem machine before they should be considered to be “stuck” containers. Any gap narrower than this will result in a blown-off. This entry can be changed here by entering a value between 0.001-21 inches.

The “maximum allowable degree change” displays a maximum number of degrees that an event's timing can be changed in one cycle. This entry can be changed here by entering a value between 0.5-50 degrees.

Selecting the cancel button will discard any changes that have been made on the screen. The accept button will retain any changes made on this screen; however, the job still must be saved on the “edit existing job” screen for the changed data to be retained for future use.

### Auxiliary Program Configuration Screen

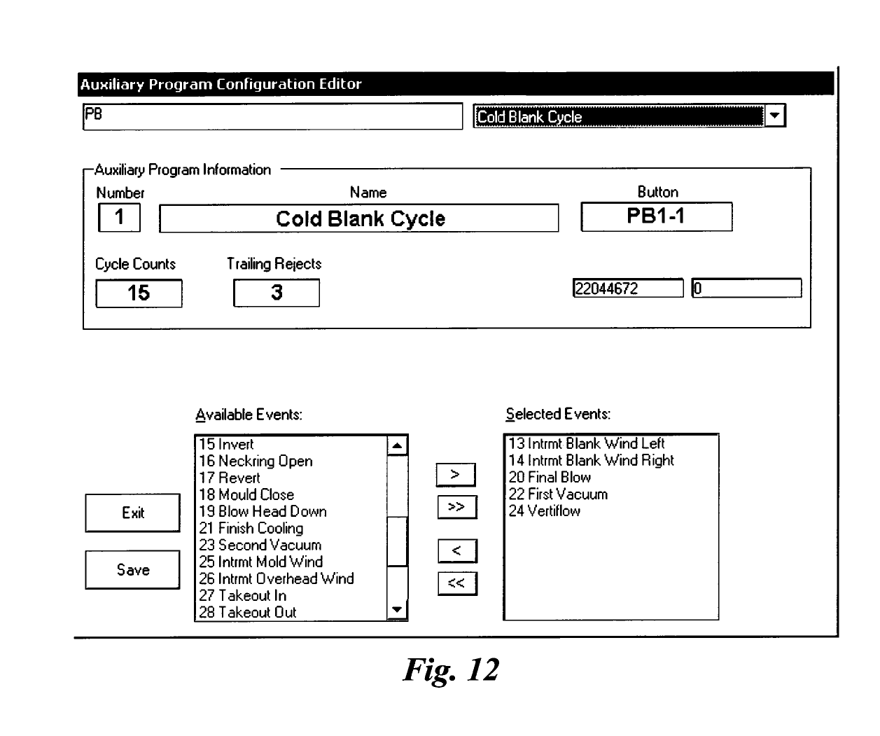

The “auxiliary program configuration” screen illustrated in FIG. 12 displays the auxiliary program configuration parameters and allows them to be modified. The information entered here is stored in the Microsoft Access database file that stores all of the job information. Descriptions of the fields (entries) on this screen are as follows:

The “process name” field displays the process name (i.e. PB, NNPB, etc.) previously assigned to the configuration. This entry cannot be modified here.

The “auxiliary program name” down-down selection box allows a user to select the auxiliary program to be modified. The “name” field allows the user to name or rename the auxiliary program name.

The “cycle counts” field allows the user to specify the number of cycles that this auxiliary program executes after the appropriate push-button on the blank or mold-side operator panel 125 is pressed.

The “trailing rejects” field allows a user to specify the number of cycles that this auxiliary program continues to reject ware after it has completed.

The “available events” list displays all of the event names that are available for including in this auxiliary program. The “selected events” list displays all of the event names that have been selected for including in this auxiliary program.

The buttons located between the “available events” and “selected events” lists are used to add or remove event names from the selected events list. The “>” button adds the currently highlighted event name from the “available” list to the “selected” list. The “>>” button adds all event names from the available list to the selected list. Likewise, the “<” button removes the currently highlighted event name from the selected list, while the “<<” button removes all event names from the selected list.

The save button saves the current auxiliary program configuration changes to be applied when the job data is saved on the “edit existing job” screen. Note again that if that save operation is not completed, then changes to the auxiliary programming configuration screen will not be retained. The “exit” button immediately discards the current auxiliary program configuration changes.

### Group Events Configuration Screen

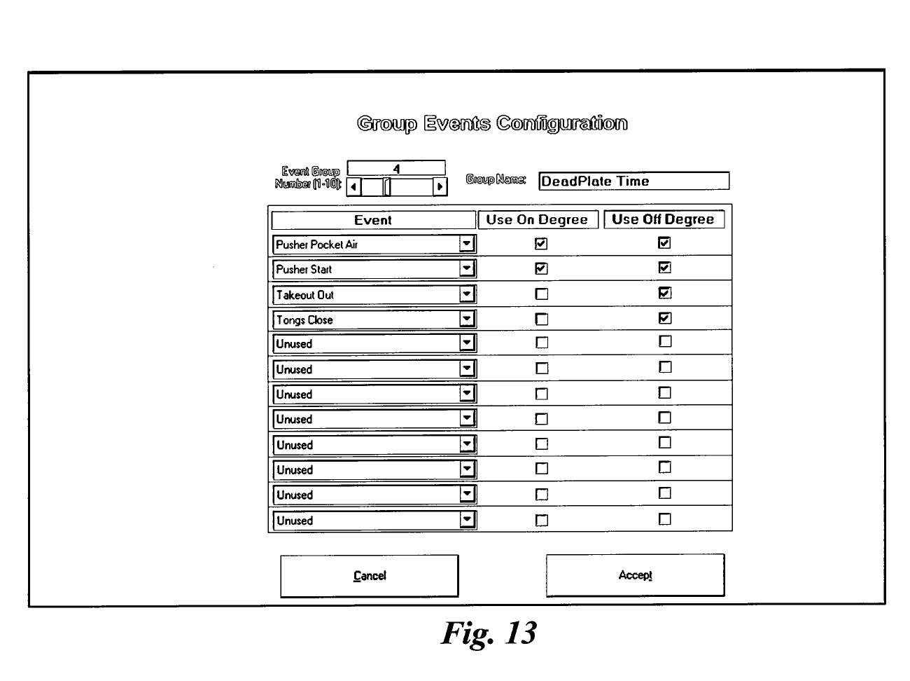

As illustrated in FIG. 13, the “group events configuration” screen allows a user to define up to 10 “group events” configurations. Group events allow multiple event timings to be adjusted at one time on the operator interface computer 104.

The “event group” scroll bar allows a user to select which group number is to be edited. The “group name” field allows one to enter a memorable name for this group.

Each group can have up to 12 events assigned to it. The events for the selected group may be selected by using the 12 drop-down lists of event names.

Each selected event can have either its “On” degree, “Off” degree, or both jogged when the event group is being manipulated on the operator interface computer 104. The user can use the “group events configuration” screen to select which degrees are jogged by placing a check mark in the check boxes “Use On Degree” and/or “Use Off Degree” for the associated Event.

### Section Angles Configuration Screen

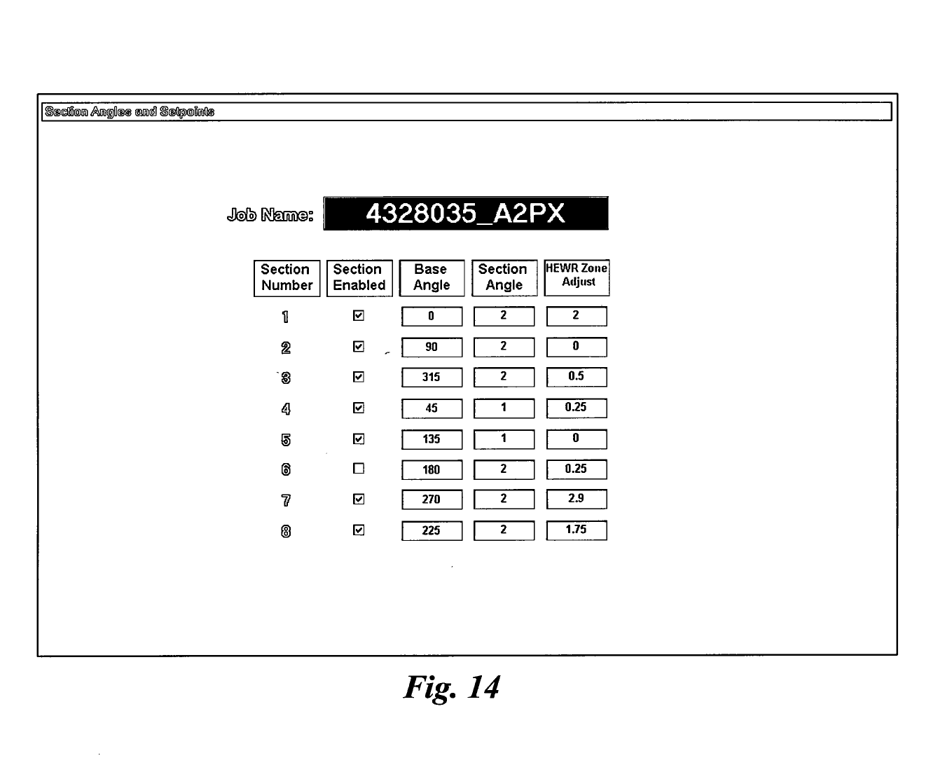

As illustrated in FIG. 14, the “section angles configuration” screen allows a user to specify the angles associated with each section for a particular job. The “job name” field displays the current job name being edited. The “section number” field displays the section numbers for the job being edited. The “section enabled” check box determines whether or not a section is enabled for the job. If the user wishes to run “reduced sections,” he or she would remove the check mark from the appropriate section numbers here.

The “base angle” (fire order) determines the firing order for job delivery to each of the sections. Typically, sections 1 and 9 are at 0 degrees in the firing order. The “section angle” (gob drop offset angle) determines the offset for each section due to the difference in gob drop travel time among sections. The “HEWR zone adjust” field stores the HEWR zone adjustment in inches for each section.

### Timing Screens

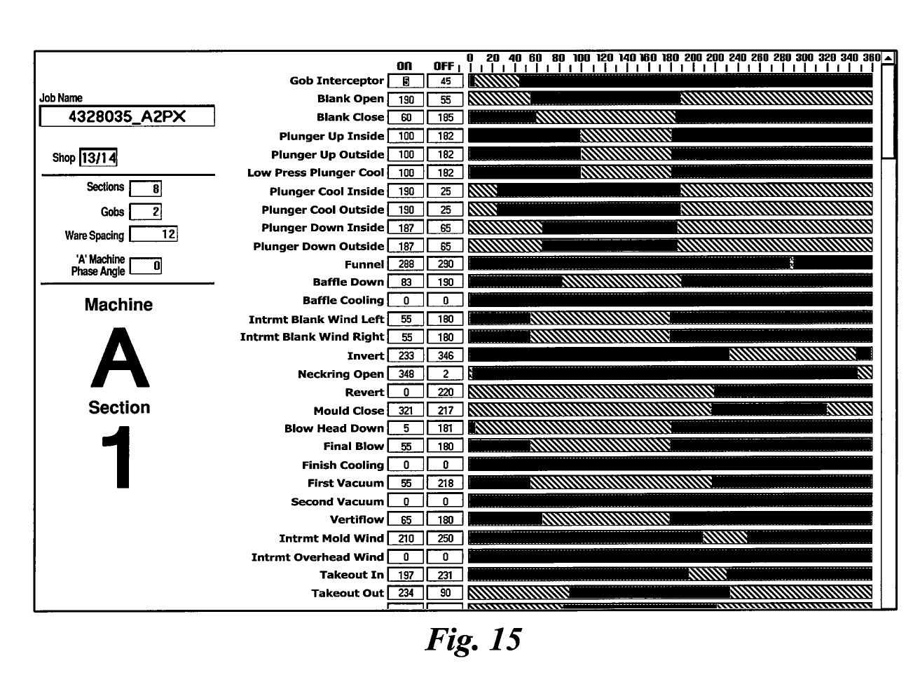

As illustrated in FIG. 15, the timing screens allow a user to specify the event timing for each section. The timing can be “run timing,” “auxiliary program timing,” or “start-part positioning timing.”

The “On” and “Off” degree fields allow the user to enter timing for the associated event. The “fill events (F8)” option displays a dialog box for selecting the sections in which events should be filled. After selecting the sections, another dialog box is displayed, which allows the user to select which events will be copied to the selected sections. The “exit (F10)” option returns the user to the “edit job configuration” screen.

### Save Job Data Command Button

Selecting the “save job data” command button on the “edit job configuration” screen saves all changes and modifications made on the individual configuration screens to the job database.

### Exit Command Button

Selecting the “exit” command button on the “edit existing job” screen discards all changes and modifications made on the individual screens, leaving the job database unaffected.

### Operator Interface Software

### Operator Interface Main Menu

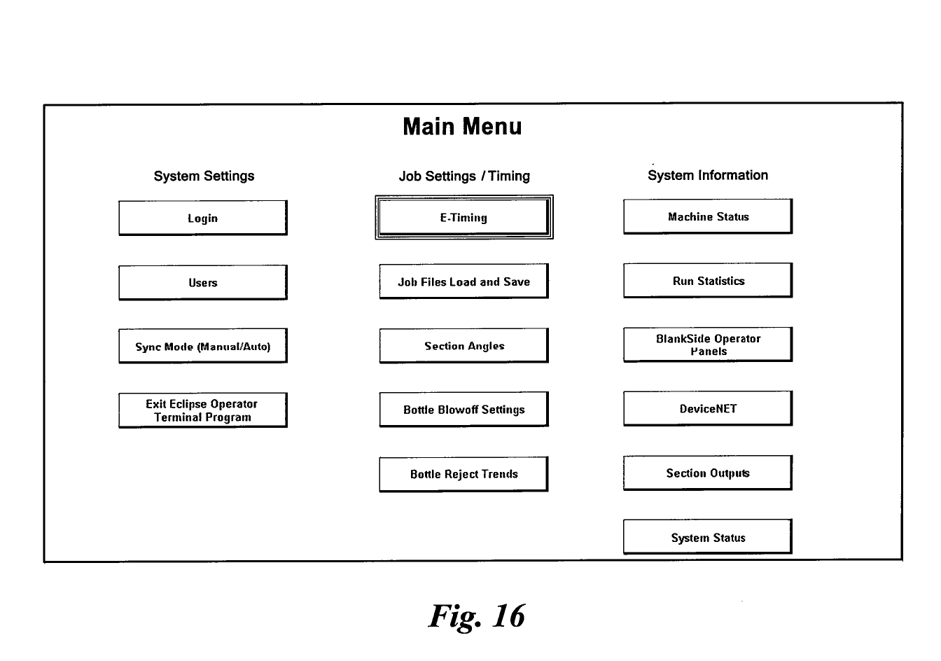

A software program in a memory associated with operator interface computer 104 in this illustrated embodiment provides a control interface for users on the production floor to monitor and manage the control system 100. The top-level interface menu is illustrated in FIG. 16 and is used to move among the various screens or displays used in the Eclipse Operator Terminal program. It contains command buttons that, when activated, display one or more associated screens.

A green rectangular border around a button indicates the currently selected command button. Any user interface object with this border is referred to as having the “focus.” This green focus rectangle is used throughout the Eclipse Operator Terminal application and indicates an object that could cause an action if the “ENTER” key were to be pressed.

A user can use the “UP ARROW” or “DOWN ARROW” keys to move the focus until the focus is positioned on the desired command button and then press the “ENTER” key to execute the associated action.

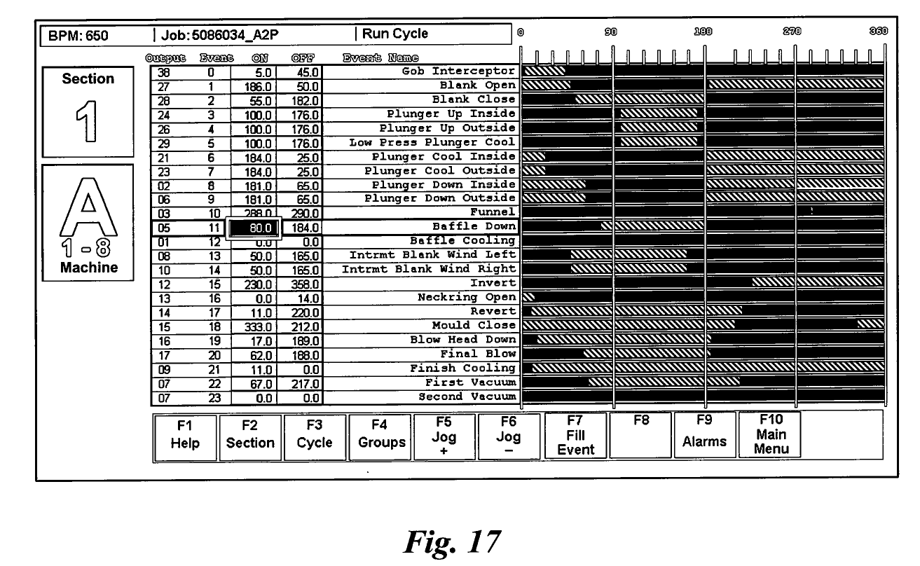

In FIG. 16 above, the focus is on the “E-Timing” command button. Pressing “ENTER” while the menu screen is in this state displays the Event Timing Screen as displayed in FIG. 17.

### Event Timing Screens

As shown in FIG. 17, the Event Timing Screen that is activated when a user selects the “E-Timing” command button on the menu of FIG. 16 reflects the number of bottles being produced by minute (“BPM”), the job name, the cycle name of the job program, the section number of the machine, the machine designator, an event timing diagram (displayed in the present embodiment as two pages, the first showing events 0-23, and the second showing events 24-47), and a menu bar reflecting the functions assigned to function keys on the keyboard. The Event Timing pages display events in numerical order. Each event is shown on a line that displays the output number, ON/OFF degree values, event name, and timing bars that illustrate the period of activation for that event.

The currently selected Event Timing (ON or OFF) is indicated by the green rectangular border around the degree value. As with the menu in FIG. 16, any object with this border is referred to as having the “Focus.” This green Focus rectangle is used throughout the Eclipse Operator Terminal application and indicates an object that causes an action when the “ENTER” key is pressed. In addition to the Degree Value receiving the focus, the currently selected Event row will be highlighted as well to make it easier to locate the information associated with the event.

Interacting with Event Timing Screens

Navigation Keys

To move between degree values within the timing screens, use the following keyboard keys:

| | |
|---|---|
| Up Arrow: | Moves the focus to the cell above the current position. |
| Down Arrow: | Moves the focus to the cell below the current position. |
| Left Arrow: | Moves the focus to the cell left of the current position. |
| Right Arrow: | Moves the focus to the cell right of the current position. |
| PgUp: | Displays Event Numbers 0-23. |
| PgDn: | Displays Event Numbers 24-47. |

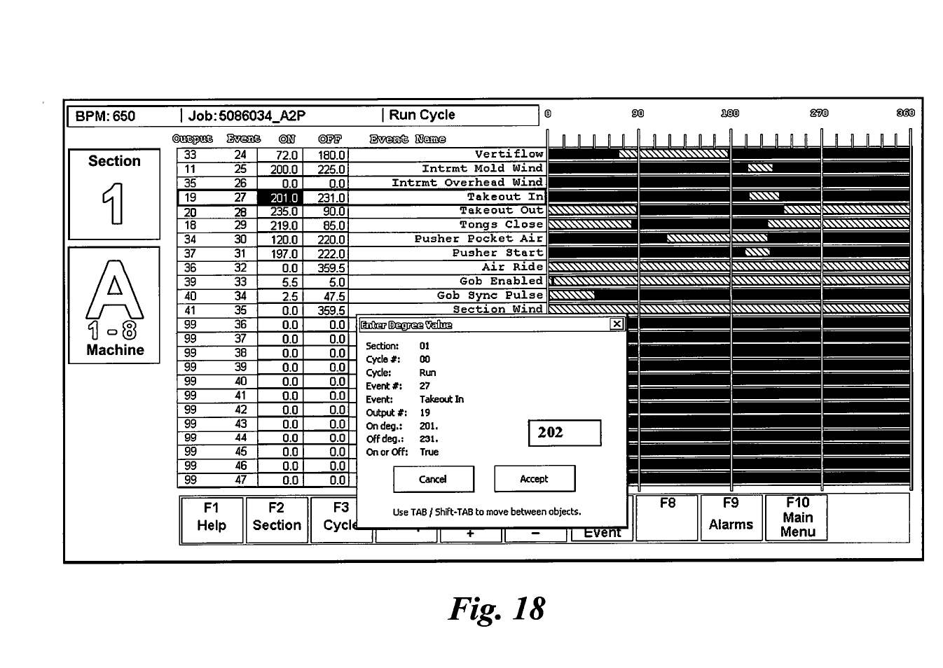

Special Keys

| | |
|---|---|
| ENTER: | Displays the “Degree Change” screen (see FIG. 18,) which |
| | permits typing in a new degree value for the currently |
| | selected event On or Off degree. |

Menu Keys

The Menu Bar displays the keyboard Function Keys (F1-F10) and their assigned function. In this example embodiment:

| | |
|---|---|
| F1: Help | Displays Help for the current screen. |
| F2: Section | Displays the “Select Section” Screen for |
| | changing the displayed Section Number. |
| F3: Cycle | Displays the “Select Cycle” Screen for changing |
| | the displayed cycle. The available “Cycles” are |
| | “Run,” “CMC (Cold Mold/Blank),” “Swab,” and |
| | “Start” (Part Positioning). |
| F4: Groups | Displays the “Select Group Events” Screen. |
| | This screen will display a button for each |
| | Event Group defined for the job. |
| F5: Jog+ | Adds 1 degree to the currently selected Event's |
| | On or Off Degree value. |
| F6: Jog− | Subtracts 1 degree from the currently selected |
| | Event's On or Off Degree value. |
| F7: Fill Event | Displays the “Fill Event Section Select” |
| | Screen for choosing to which sections the |
| | currently selected event's On or Off Degree |
| | value will to be copied. |
| F9: Alarms | Displays the Alarm Summary Screen. |
| F10: Main Menu | Displays the Main Menu Screen, which allows |
| | viewing other key components of the Operator |
| | Interface. |

### Event Timing Changes

The On/Off degree values on the Event Timing Screens can be changed by “Jogging” the value Up 1 degree by pressing “F5,” or Down 1 degree by pressing “F6.” To change a value by directly entering a numeric value, press the “ENTER” key while the value has the focus. The Degree Change Screen (see FIG. 18) appears when the “ENTER” key is pressed. It displays information about the currently selected Event's On or Off Degree, including the current Degree Value.

The user can type a new degree value (0-359.5) using the keyboard's numeric keys. To accept the change, use the “Tab” key to move the focus to the “Accept” button and press the “Enter” key. To cancel the change and revert to the previous value, us the “Tab” key to move the focus to the “Cancel” button and press the “Enter” key.

### Select Section (F2)

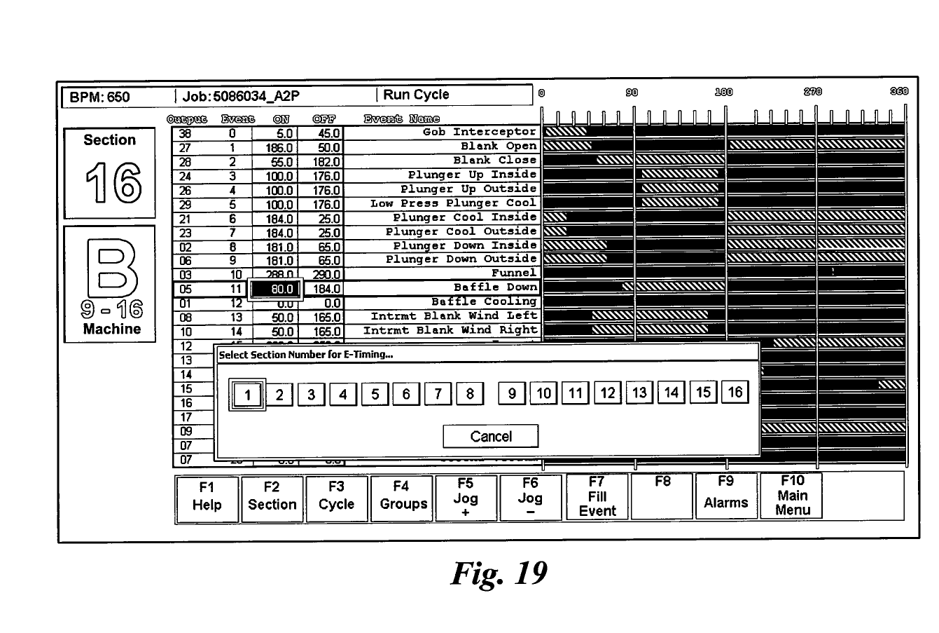

Pressing Function Key “F2” while on an E-timing Screen displays the “Select Section” screen. The “Select Section” screen (see FIG. 19) allows you to show the job data for another section. To move to another section when this screen is displayed, press the “RIGHT ARROW” or “LEFT ARROW” keys until the focus is positioned on the section that you want to move to, then press the “ENTER” key. To remain on the currently selected Section, move the focus to the “CANCEL” button, then press “ENTER.”

### Fill Event (F7)

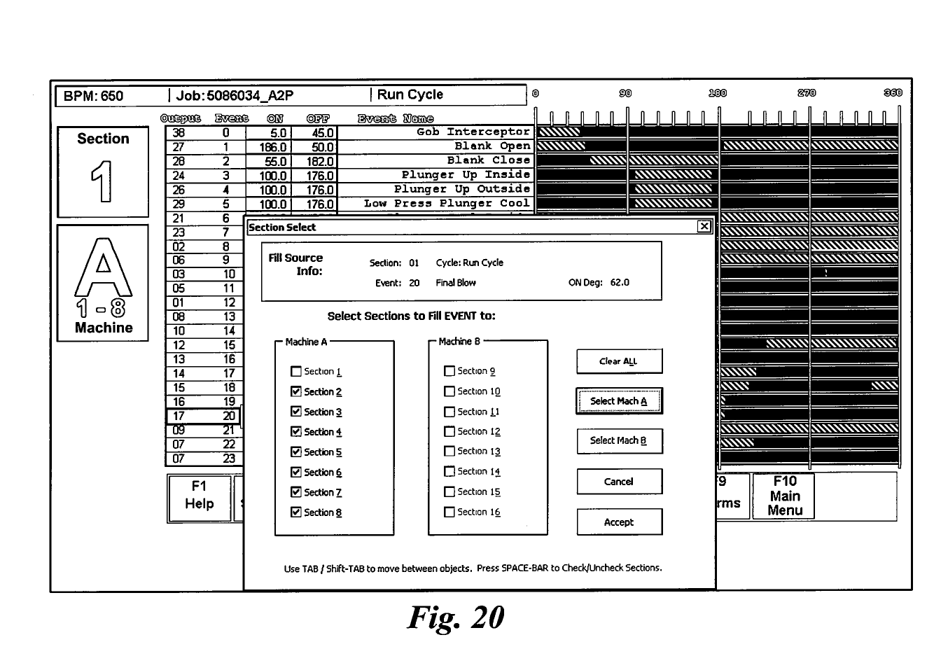

Pressing Function Key “F7” while on an E-timing Screen displays a “Section Selection” screen as shown in FIG. 20. This screen is used to select the sections to which the currently selected timing value will be copied. In the case of a tandem machine, only the sections on the currently selected machine will be available for filling this top portion of this screen shows information relative to the event being copied to other sections.

Use the “Tab” key to move the focus forward to the next object, and a combination of the “Shift” and “Tab” keys to move the focus backwards to the previous object. When the focus is positioned on a Section Number “Check Box,” using the “Space Bar” toggles between selecting and deselecting that section from the selection set. When the focus is positioned on a command button, use the “ENTER” key to execute the associated action.

The command buttons on the Section Selection Screen perform the following actions:

| | |
|---|---|
| “Clear ALL” | Removes all sections from the selection set. |
| “Select Mach A” | Adds all of the sections from “A”-Machine |
| | to the selection set. |
| “Select Mach B” | Adds all of the sections from “B”-Machine |
| | to the selection set. |
| “Cancel” | Closes the “Fill Event” screen without |
| | performing the Fill operation. |
| “Accept” | Closes the “Fill Event” screen and performs |
| | the Fill operation. |

On this screen and other dialog screens certain letters and numbers have an underline beneath them. This underline indicates a “Quick Key” for the associated object. By holding down the “ALT” key and depressing the “Quick Key,” the associated command button is activated, or the operation is performed.

| | |
|---|---|
| Examples: | Holding down the “ALT” key and pressing the “A” key |
| | while the Section Selection Screen is displayed will cause |
| | the action associated with the “Select Mach A” command |
| | button to be performed. Holding down the “ALT” key and |
| | pressing the “4” key will toggle Section number # 4's |
| | “check box” (see FIG. 20) between selected and de-selected. |

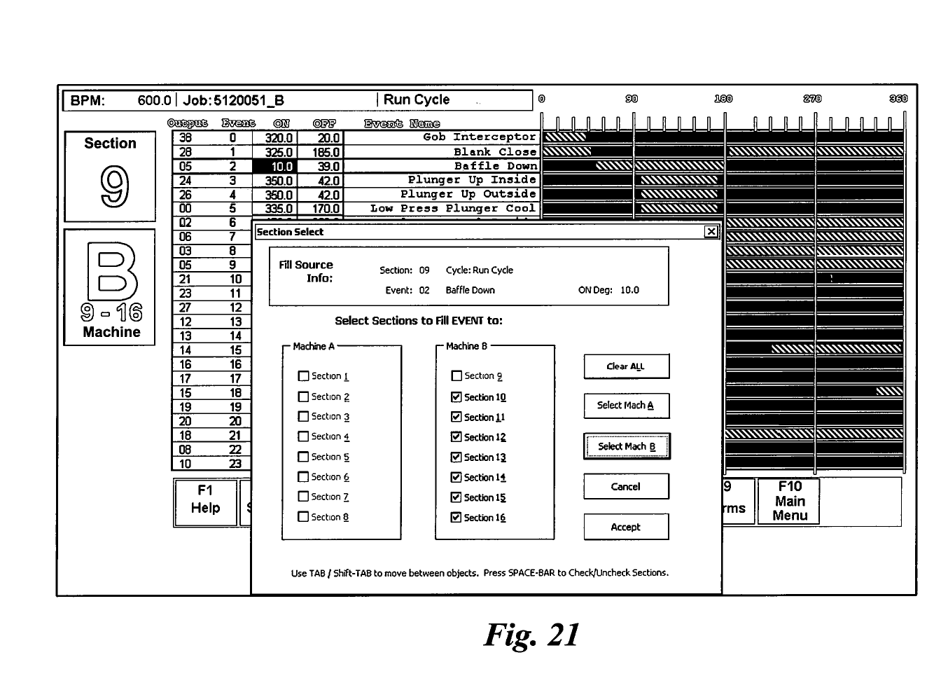

FIG. 21 illustrates the “Fill Event Section Selection” screen for the “B”-Machine. This screen is displayed if a section located on Machine “B” was being displayed when the “F7” key was pressed.

### Event Groups (F4)

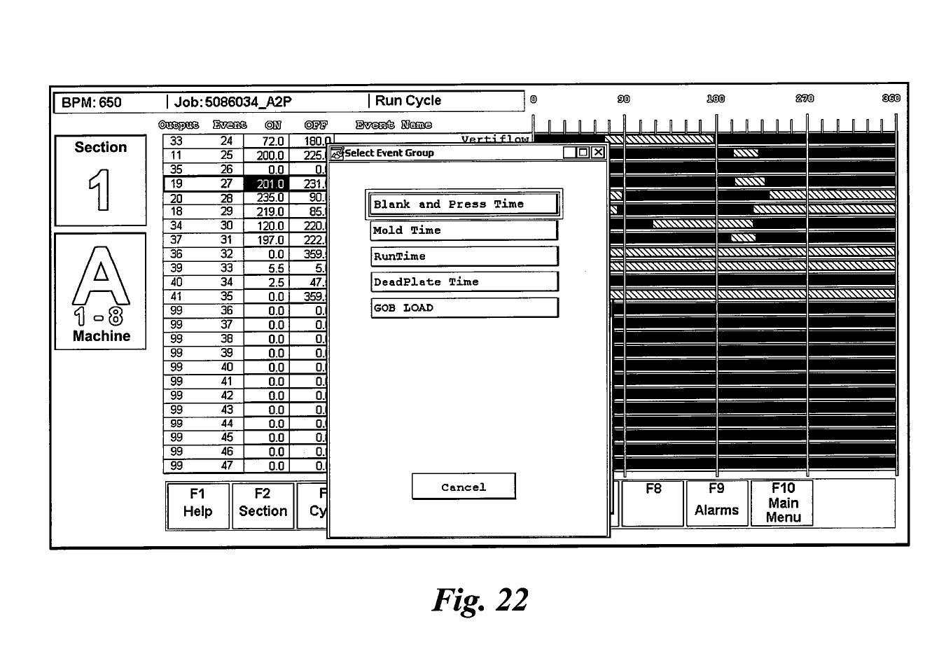

Pressing Function Key “F4” while positioned on a “Run Cycle” E-timing Screen, displays a “Select Event Group” screen as illustrated in FIG. 22. This screen is used to select from a list of defined “Event Groups.” The Event Groups are created in the “Job Editor” program, which resides on the Control Room Terminal 102. The user presses the “UP ARROW” or “DOWN ARROW” keys until the focus is on the Event Group that he or she wants to display, then presses the “ENTER” key. To Cancel, the user moves the focus to the “CANCEL” button, then presses “ENTER.”

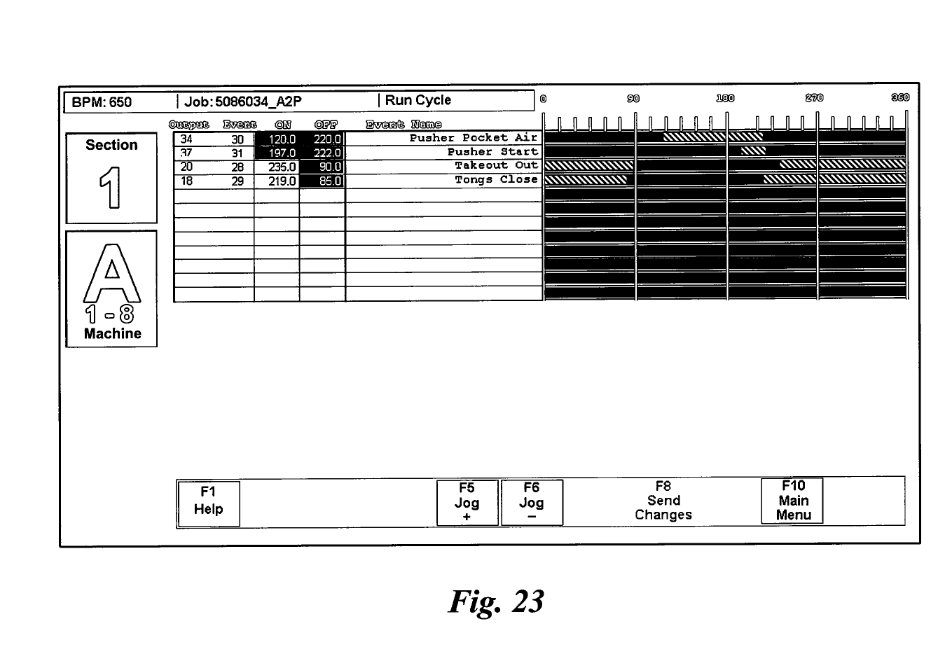

Event Groups (see FIG. 23) allow multiple Event Timing degree values within a section to be adjusted simultaneously. The Event timing is adjusted by pressing “F5” to Jog Up the degree values by 1 degree, or by pressing “F6” to Jog Down the degree values by 1 degree.

Each Event defined in the Group can have its ON Degree, OFF Degree, or Both ON & OFF Degrees defined as being associated with the Group. These are indicated on the Event Group Screen display by a Black background and Yellow numbers. A Blue background and White numbers indicate non-associated degree values.

When one of the Jog +/− buttons is pressed, all of the associated degree values increment or decrement by 1 degree. Note, however, that the new values are not sent to the Eclipse Timing system until the “F8” “Send Changes” key is pressed. Pressing the “F8” key also returns you to the previous E-Timing screen. To leave this screen without accepting any pending changes, press the “F10” key.

### Auxiliary Cycles (F3)

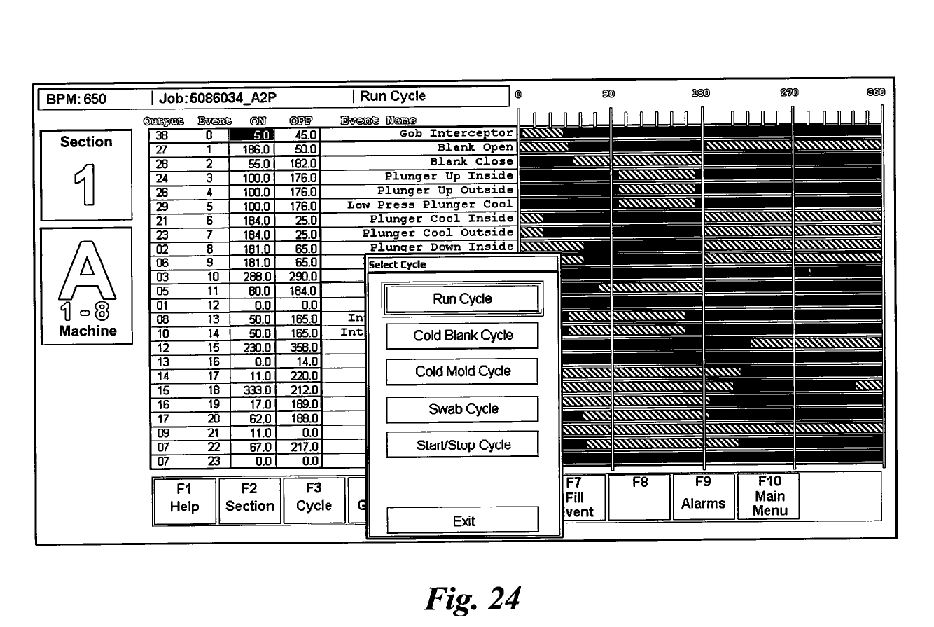

Pressing Function Key “F3” while positioned on an E-timing Screen displays a “Select Cycle” screen as illustrated in FIG. 24. This screen is used to select from a list of defined “Auxiliary Cycles.” Auxiliary Cycles are created in the “Job Editor” program, which resides on the Control Room Terminal 102. The user can use the “UP ARROW” or “DOWN ARROW” keys until the focus is on the desired Auxiliary Cycle, then press the “ENTER” key. To Cancel, the user moves the focus to the “Exit” button, then presses “ENTER.”

Auxiliary Cycles are special cycles that allow different timing (for the Events that are included in the Auxiliary Cycle's definition) to be realized upon activating the cycle. Auxiliary Cycles are activated by pressing their associated Push Button(s) on the Blank and/or Mold side operator panels 125.

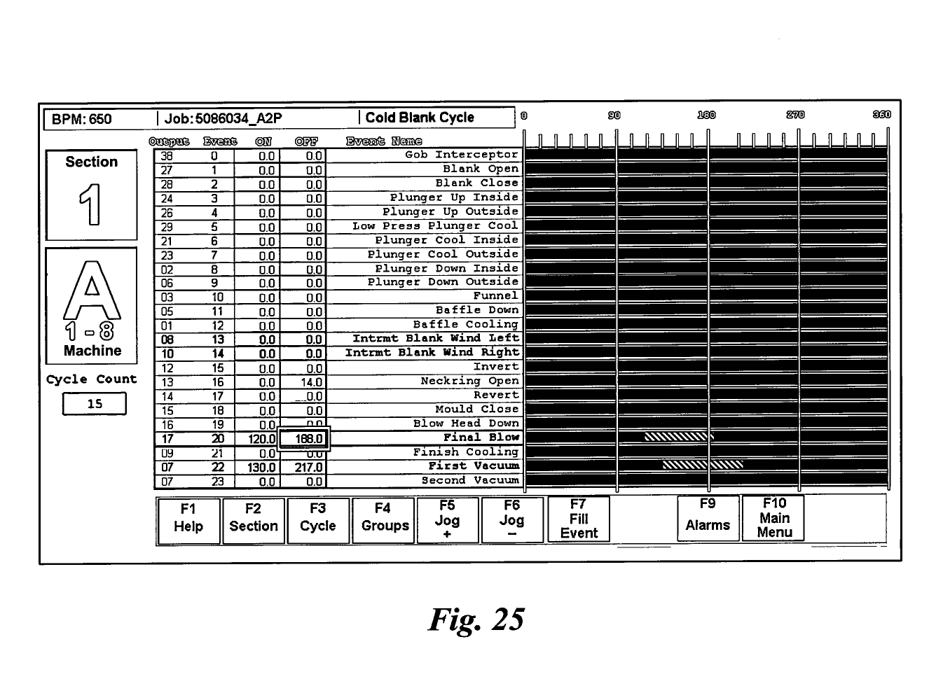

As with the “Run Cycle” Timing Screen, the auxiliary cycle management screen illustrated in FIG. 25 allows degree changes, but only for the associated Events. The degree values entered here only affect the Event Timing while the Auxiliary Cycle is active. While on this screen, pressing the “F4” key allows the user to change the number of machine cycles that this Auxiliary Cycle will be active.

### Angles

### Types of Angles

This description of Angles relates to a system that includes a tandem machine with the APPLIED MOTIONS Drive System. Each Section has 3 angle offsets that can affect when events occur in relation to the Master Pulse, a continuous train of synthetic pulses generated by the APPLIED MOTIONS drive system.

The Machine Differential Angle allows offsetting each half of the tandem machine from the Master Pulse. Generally, the A-Machine's “Machine Differential Angle” is left at 0-degrees, while B-Machine's is adjusted to increase or decrease the separation between each machine's containers on the flight conveyor.

The Base Angle (Fire Order Degrees) determines the section firing order within the machine. Similarly, the Section Angle (Drop Offset) compensates for the variation in Gob Drop travel time down the various lengths of trough. This Angle affects events configured as “Section Angle” dependent. Although most events are configured as “Section Angle” type events, some events such as “Gob Loading,” “Air Ride,” “Pusher Start” and “Pocket Air” are not. They are configured as “Base Angle” dependent and are only affected by the Machine Differential and Base Angle offsets.

### Machine Differential Angle

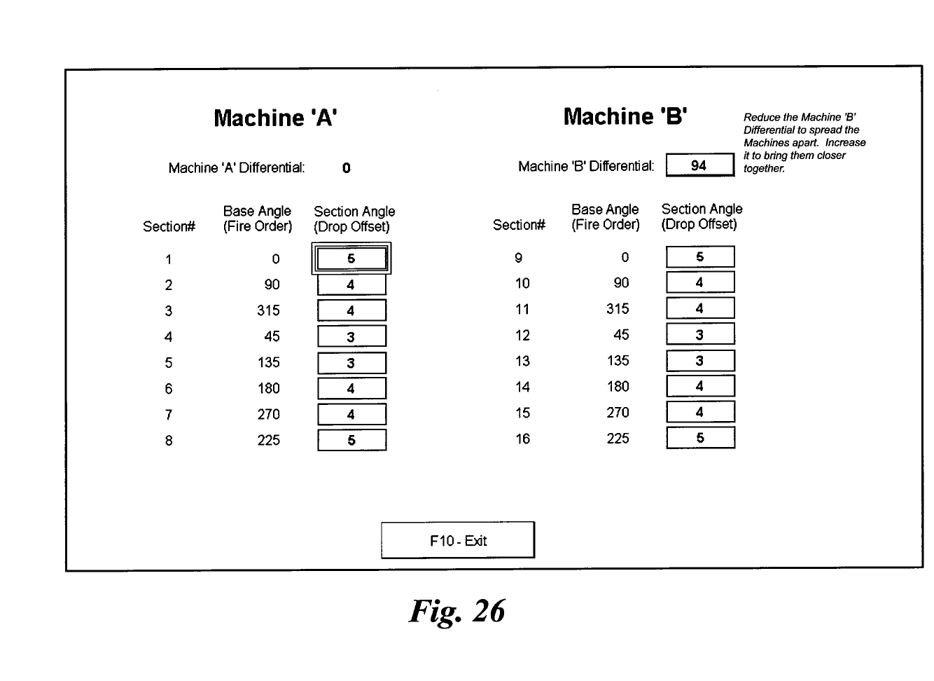

To change the “Machine Differential” Angle, the user presses “TAB” or “UP/DOWN ARROW” keys to move the Focus to the numeric entry box for “Machine—B Differential” (see FIG. 26) then presses the “ENTER” key.

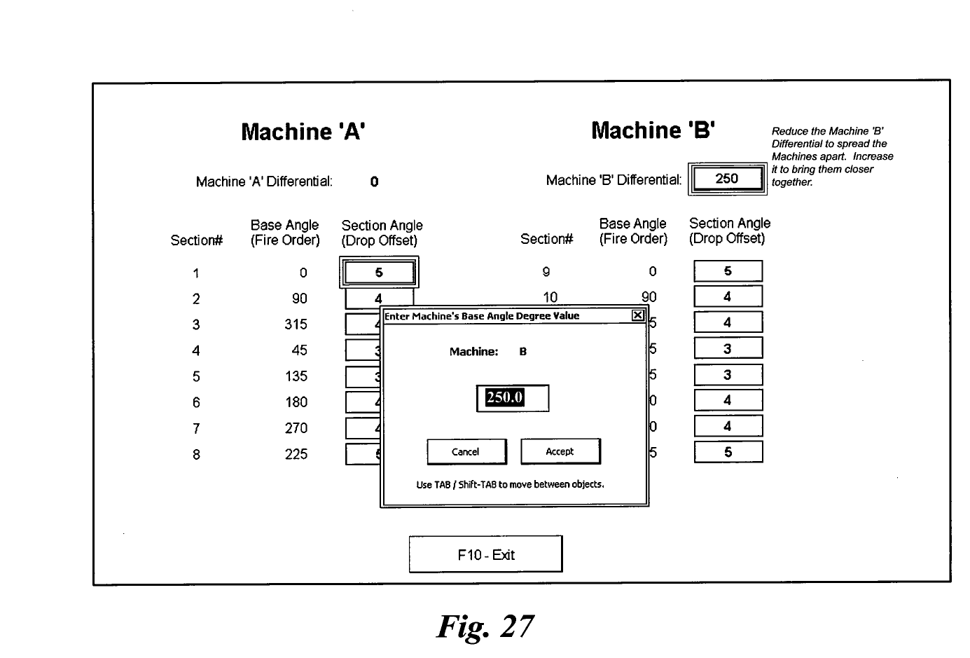

As illustrated in FIG. 27, a dialog box appears with a numeric entry box that allows entering a new degree value (0-359.5). After entering a new value, moves the focus to the “Accept” command button using the “TAB” key, then presses “ENTER.” The dialog box disappears and the Machine B Differential numeric display begins counting up or down as the new offset angle is being achieved at a rate of ½ degree per machine cycle.

### Section Angle

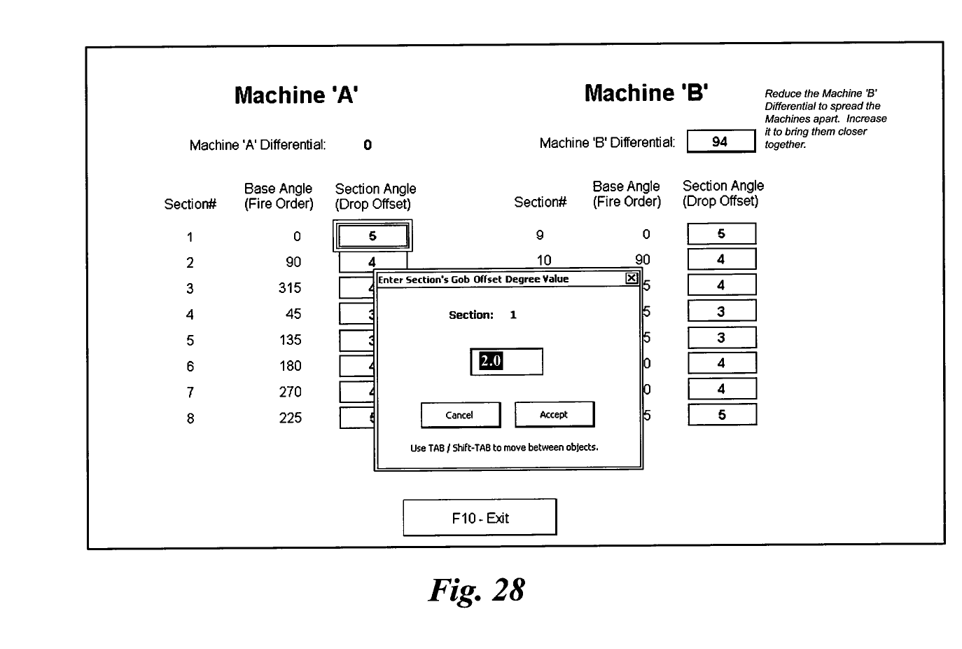

To change the “Section” Angle, the user presses the “TAB” or “UP/DOWN ARROW” keys to move the Focus through the Angles screen in FIG. 26 to the numeric entry box for the desired Section, then presses the “ENTER” key. As illustrated in FIG. 28, a dialog box appears with a numeric entry box that allows entering a new degree value (0-359.5). After entering a new value, the user moves the focus to the “Accept” command button using the “TAB” key, then presses “ENTER.” The dialog box disappears and the “Please Wait” message displays until the new Section Angle offset has become active.

The Section Angle (Drop Offset) is usually used to bring a Section to the Drop. If all sections on a machine need to move closer to or further from the drop, then use the APPLIED MOTIONS Drive System's “Feeder Phase” offset entry (for the appropriate machine A or B) to bring the Drop to the sections instead. See the “Drive System Synchronization” section of this disclosure for more information on synchronizing with the Drive system.

### Job Files

### Job File Load/Save Screen

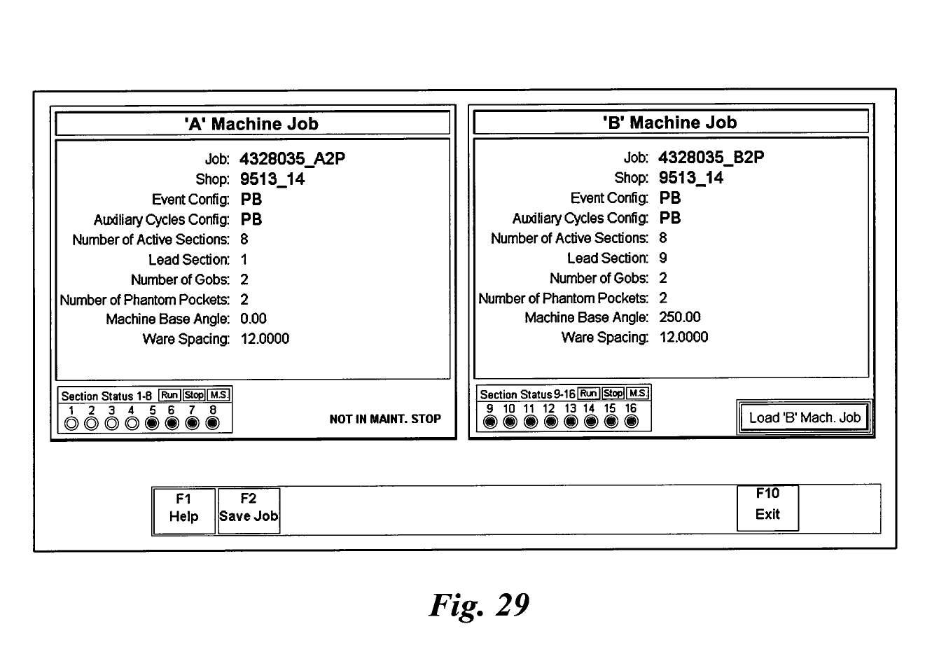

As shown in FIG. 29, the Job Load/Save Screen displays information relative to the job that is currently loaded on each machine of the tandem. The information for the job on “A” Machine is on the left that for the job on and “B” Machine is on the right.

The Job Data is stored in a MICROSOFT ACCESS database on the Control Room Terminal 102. This data is read from the Database and sent to the Eclipse Controller on a Job Load. In order to perform a Job Load, all sections on that particular machine must be in a Maintenance Stop state. Each machine has “Section Status” indicators that show if the sections are running, stopped or in a Maintenance Stop state. When all of the sections for a machine are in Maintenance Stop, a button appears on the Job Load/Save Screen with the title “Load ‘A’ Mach. Job” or “Load ‘B’ Mach. Job.” If any sections are not in Maintenance Stop state, a red message “NOT IN MAINTENANCE STOP” appears in the button's place.

### Loading Jobs

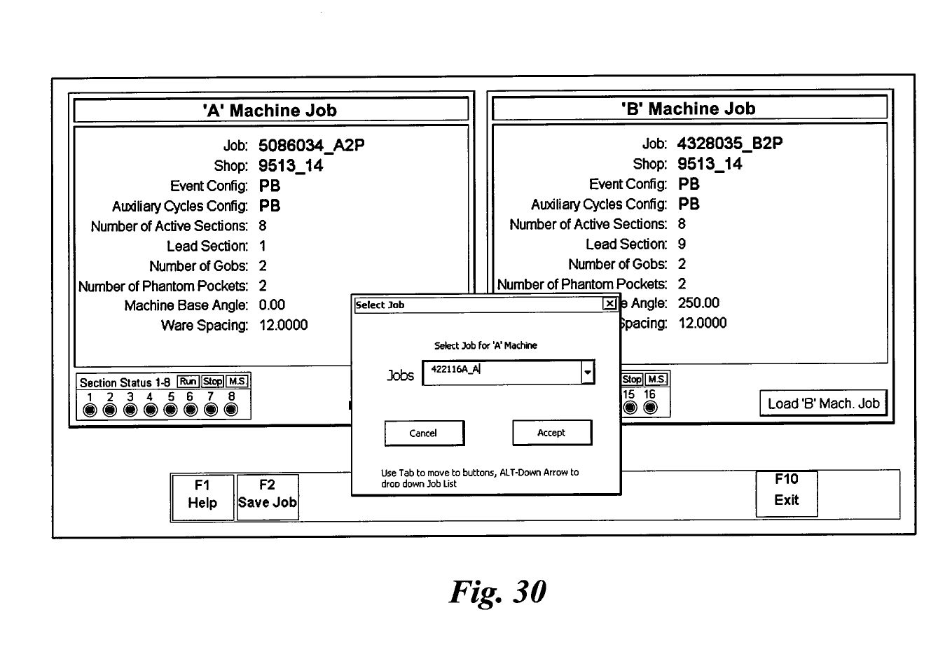

Once all of the sections are in Maint. Stop, one can use the “TAB” key to move the focus to the appropriate “Load” button on the Job Load/Save Screen and press “ENTER.” This displays a “Select Job” dialog box screen as shown in FIG. 30. In this dialog box is a Drop-Down list that displays all of the Job names for that particular machine. Once this Drop Down list receives the focus, one can use the UP/DN ARROW keys to move through the job names. As an alternative, one can press the “ALT” key and the “DOWN ARROW” key to open the list box up larger, which makes it easier to see the job names. The UP/DN ARROW keys to move to the appropriate Job name, then the “TAB” key can be used to move the focus to the “Accept” command button. The user then presses “ENTER.”

This will start the Job Load procedure. While loading a job, there will be a “Job Load Status” screen displayed that indicates the progress of the job load, as will be understood by those skilled in the art. Once all of the Job Data has been sent to the Eclipse controller and read back into the Operator Interface (verified), the progress message will indicate that it is “Done Downloading to Eclipse,” and a button appears to remove the progress display.

### Saving Jobs

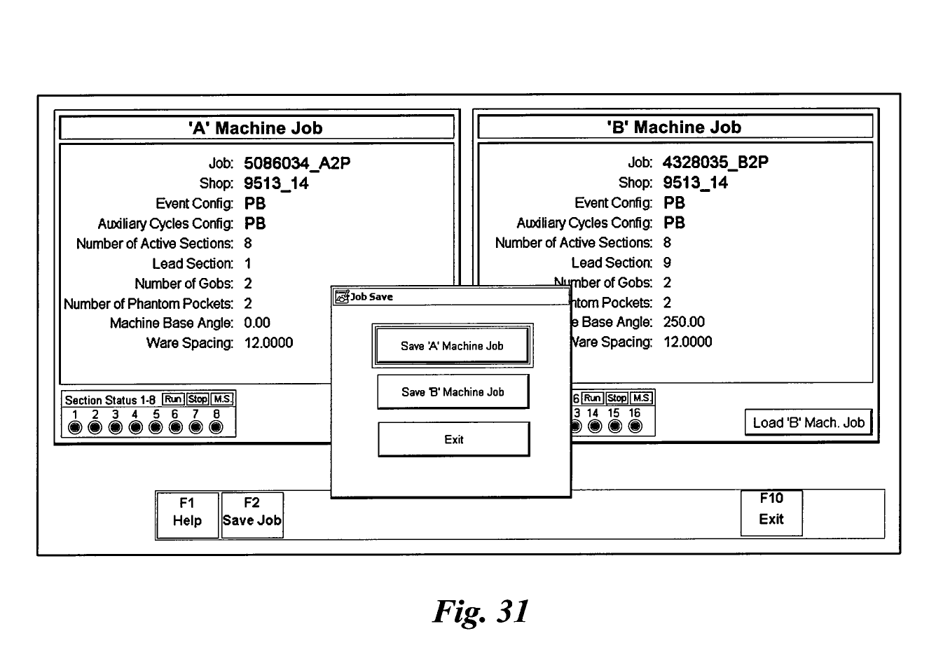

At any time a user can save the job running on either “A” or “B” machine without interrupting the machine. To save a job, press “F2” and the “Job Save” dialog box will be displayed as illustrated in FIG. 31. On this dialog box are 3 command buttons, “Save ‘A’ Machine Job,” “Save ‘B’ Machine Job” and “Exit.” One can use the “TAB” key to move the focus between these buttons. Once the appropriate Save button has the focus, press the “ENTER” key to begin the job save procedure. This will cause all of the updated settings and timing to be stored in the Job Database file on the Control Room Terminal 102. After the save procedure has completed, a message box appears indicating that the job has been saved. Press “ENTER” to remove the message box.

### Diagnostics

Accessing Diagnostics from Main Menu

The main menu provides access to the various diagnostic screens as indicated in FIG. 16. The “UP ARROW” or “DOWN ARROW” keys can be used until the focus is positioned on the desired command button on the main menu, and then press the “ENTER” key to display the associated Diagnostic screen.

### Section Output Status

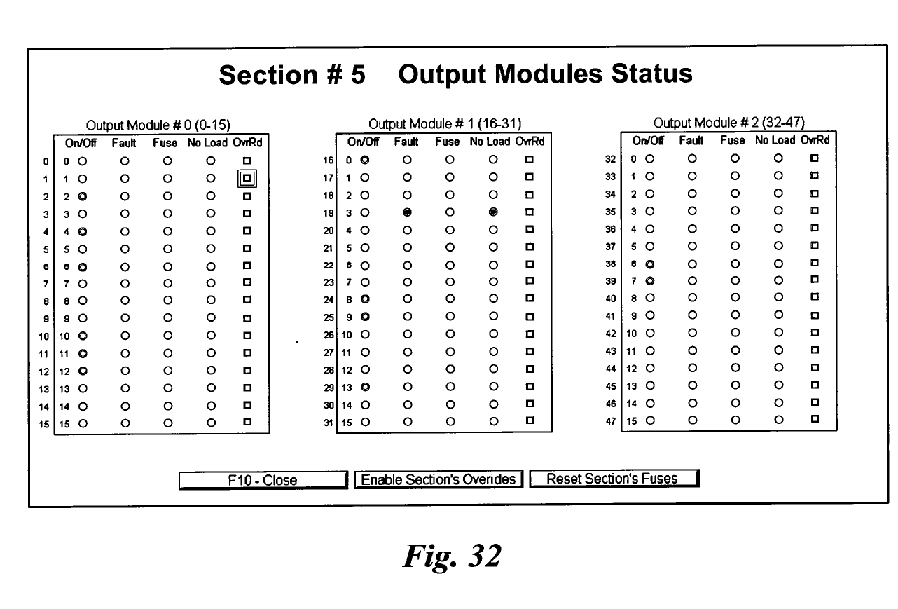

The Section Output Status Screen, an example of which is shown in FIG. 32, displays the status of all 48 (16 outputs per module) outputs associated with a section. Each output has 4 columns of status indicators. The first column indicates the On/Off status in which the LED will be green when the output is ON, and black when the output is OFF. The second column indicates whether the output has a fault. The fault LED will be red if a fault is detected and black if no faults are detected for the output. If a fault is detected for an output, the next two columns will indicate whether it is a short circuit or open wire. If a short circuit is detected, the third column LED will be red. If an open wire is detected, the fourth LED will be red.

When a short circuit is detected as indicated by the “Fuse” column LED being red, the physical output module in the Eclipse Controller trips an electronic fuse. This electronic fuse will remain tripped until cleared by either pressing the “Reset Section's Fuses” command button on this screen, or by cycling the Maintenance Stop circuit for the given section.

The fifth column is an Override button for each output. These overrides are only available in a “Stopped” condition, and then only after the “Enable Section's Overrides” button has been activated on this screen. Use the “UP ARROW” or “DOWN ARROW” keys until the focus is positioned on the Override command button that you want, and then press the “ENTER” key to activated (energize) the associated output. The override button will turn red, indicating that it has been activated, and the On/Off status LED will turn green. To cancel the override, simply press the “ENTER” key again.

### DeviceNET Status

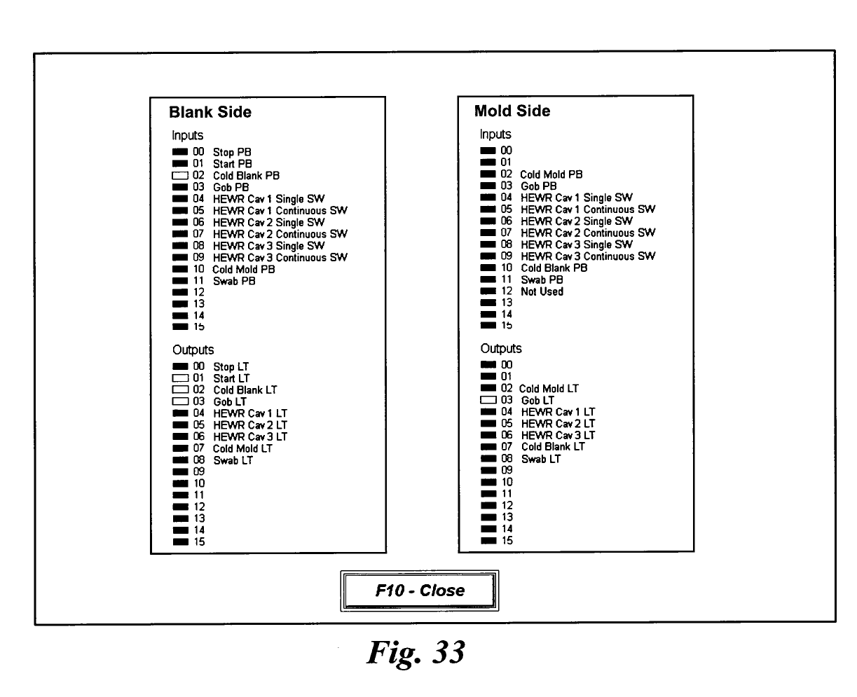

As shown in FIG. 33, the DeviceNET Status Screen displays the status of the push buttons and lamps on the Mold and Blank side operator panels 125. The “Inputs” (push buttons) status is displayed at the top, while the “Outputs” (lamps) status is displayed toward the bottom.

To test the operation of the buttons, place the section in Maintenance Stop then activate the DeviceNET inputs by pressing the desired buttons. While the button is depressed the indicators on this screen will turn Green to verify their operation. When the Eclipse system energizes one of the lamps, the associated DeviceNET output can be verified on this screen. If this screen indicates that the lamp is on or flashing, but the actual lamp does not light, the LED and/or LED module located on the Mold/Blank side operator panel may need to be replaced.

### Section Remote Control

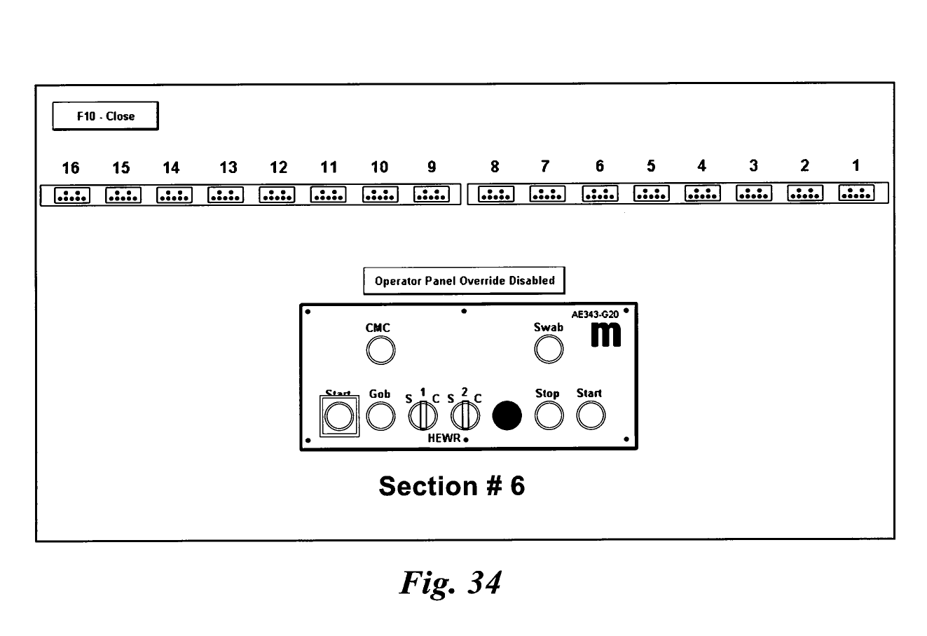

The Section Remote Control Screen, illustrated in FIG. 34, allows a section to be controlled from the operator interface program by using a graphical representation of the Blank Side operator panels. Of course, this capability should only be used by qualified personnel, and then only for as long as it takes to repair or replace the physical operator panel or DeviceNET connection to the operator panel. Furthermore, this Remote Control should only be executed while a second operator is at the section to warn others of impending movement.

In the event that a DeviceNET board or a pushbutton on the operator panel fails, this screen allows all Blank Side Operator Panel capability to be exercised at the Eclipse Operator Terminal 102. The ARROW keys are used to position the focus on the section that is to be controlled, then the user presses “ENTER.” He or she verifies that the desired Section Number is displayed below the image of the panel, then by using the ARROW or TAB keys, positions the Focus on the desired switch, then presses “ENTER” to activate or deactivate that function depending on whether it was previously inactive or active. The Remote Control Screen indicates inactive functions (i.e. CMC, START, STOP, HEWR, etc.) by a gray switch/push button symbol. Active functions are indicated by the switch or push button being the color of the actual lamp used at the operator panel on the Blank Side of the machine.

### Alarm Screen

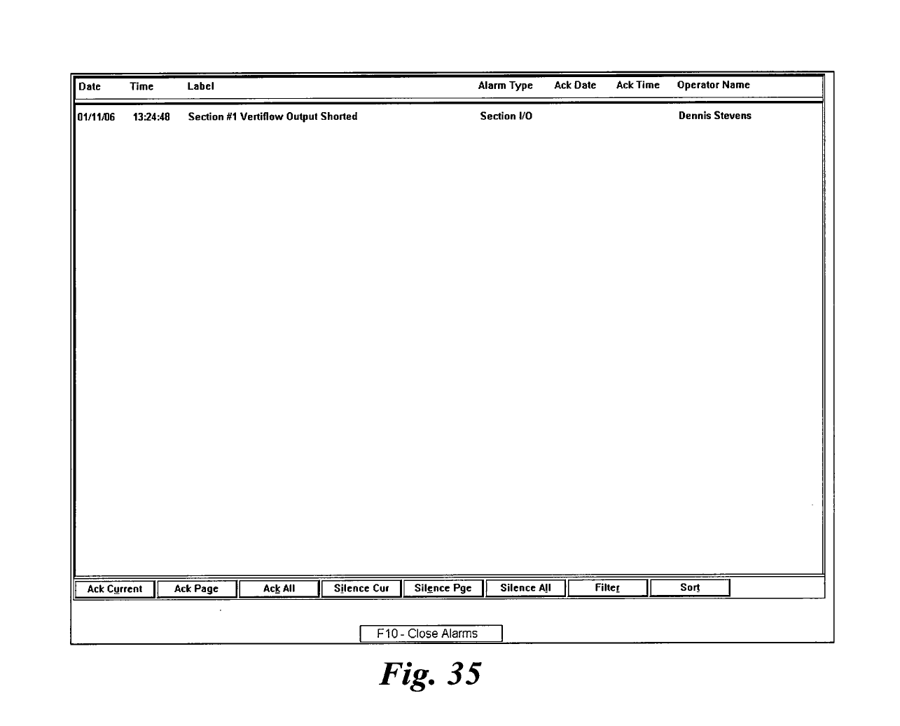

As shown in FIG. 35, the Alarm Screen displays all current and non-acknowledged alarms for the Eclipse E-Timing system. Pressing “PGUP” and “PGDN” scrolls through the pages of alarms. Once an alarm condition no longer exists, the alarm message will change colors but still be displayed until it is acknowledged. To acknowledge a single alarm, move the focus to the alarm and press “ALT-C” (press the “C” key while holding down the “ALT” key). To acknowledge all alarms visible on the current page press “ALT-G.” To acknowledge ALL alarms press “ALT-K.” To exit this screen, press function key “F10.”

### Machine Status

### Shop Status

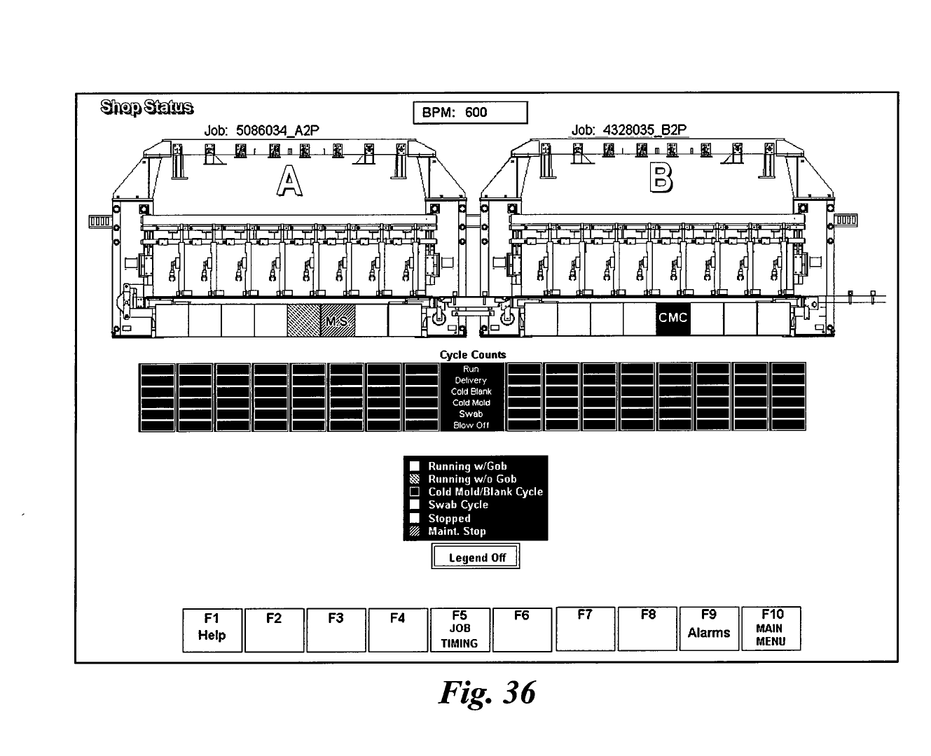

The Shop Status Screen displays the run status of all sections, as shown in FIG. 36. The BPM (Bottles per Minute) production rate and associated job names are displayed above the machine graphic. Each section's current run status is depicted by a colored box on the machine graphic. Below the machine graphic is a legend explaining the conditions that the colors represent.

Also below the machine graphic is a table of “Cycle Counts.” These counts represent the number of machine cycles that each section has Run, Run with Gob Delivery, and Run executing an Auxiliary Cycle (Cold Mold, Cold Blank, and Swab). It also has a counter that displays the total number of bottles blown off for each section, either through HEWR or Auxiliary Cycles. To reset the Cycle Counters, a user can go to the “Run Statistics Screen” by using the “TAB” key to move the focus to the Cycle Counts Table and press “ENTER.”

### Run Statistics

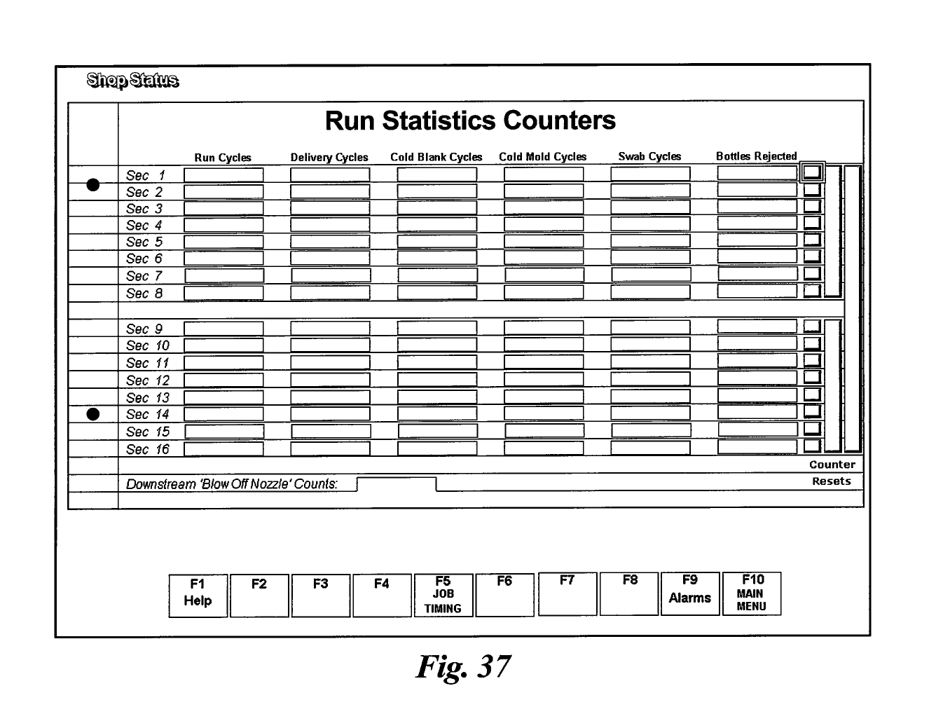

As illustrated in FIG. 37, Run Statistics Screen displays the same “Run Statistics” as shown on the “Shop Status” screen, but it uses larger text and is easier to read. The Counters can also be Reset to 0 (zero) on this screen, either by Section, for a Single Machine, or for the Entire Shop. At the right side of this screen are a series of buttons arranged into 3 columns. The smaller buttons reset all of the counters for the Section Number referenced on the same row. The middle two buttons reset all of the counters for all of the sections on that particular half of the tandem machine. The large button resets all of the counters for all sections on both halves of the tandem machine. To Reset a set of counters, a user presses the “TAB” key to move the focus to the desired button, then presses “ENTER.”

### Hot End Ware Reject (HEWR)

### HEWR Parameters

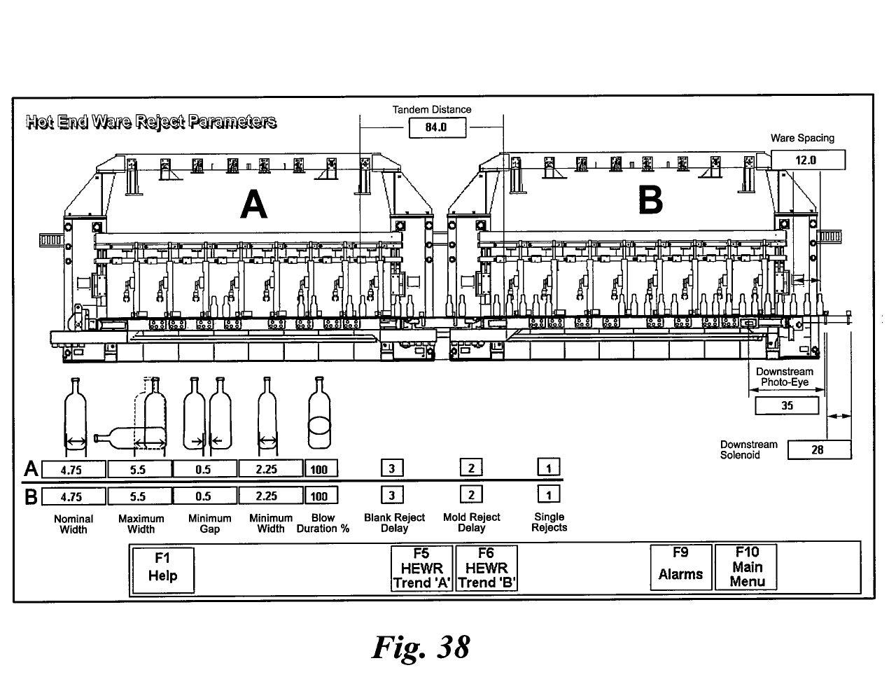

As illustrated in FIG. 38, the HEWR Parameters Screen allows users to view and modify numeric values that are used in controlling the Hot Bottle Reject system. These values are considered either Conveyor Data or Container Data.

Conveyor Data

There are four values displayed in inches on this screen that are used to track the bottles' movement down the conveyor. They are “tandem distance” (the distance between the centerlines of the two inside sections of a tandem machine), “ware spacing” (the distance between the lead containers of two neighboring sets of ware on the conveyor), “downstream photo eye” (the distance from the centerline of the last section to the HEWR downstream photo eye), and “downstream solenoid” (the distance between the photo eye and the reject air nozzle). Tandem distance and ware spacing can only be changed in this embodiment by editing the relevant job in the “job editor” and then re-downloading the job data. The downstream photo eye and downstream solenoid values can be modified by the user with the interface on the screen.

Container Data

There are eight container data values displayed in inches on this screen that can be modified independently for each machine. They are the “normal width” (diameter) of the containers, “maximum width”; or the largest container diameter allowed before a container is considered too wide (e.g., a bottle that is down or stuck to another) and rejected; “minimum gap”; or the smallest gap between two containers that is allowed before they are considered too close to each other (e.g., stuck) and rejected; “minimum width,” or the smallest container diameter allowed before a container is considered too narrow (e.g., a broken bottle) and rejected; “blow duration %” or the percentage (50-100%) of the container's diameter that the reject nozzle should blow; “blank reject delay,” or the number of cycles after a blank-side HEWR switch is activated to wait before the desired ware is in the pusher mechanism; “mold reject delay,” or the number of cycles after a mold-side HEWR switch is activated to wait before the desired ware is in the pusher mechanism; and “single rejects,” or the number of cycles of ware to reject when a “single reject” HEWR switch has been activated.

### Section's HEWR Zone Adjust

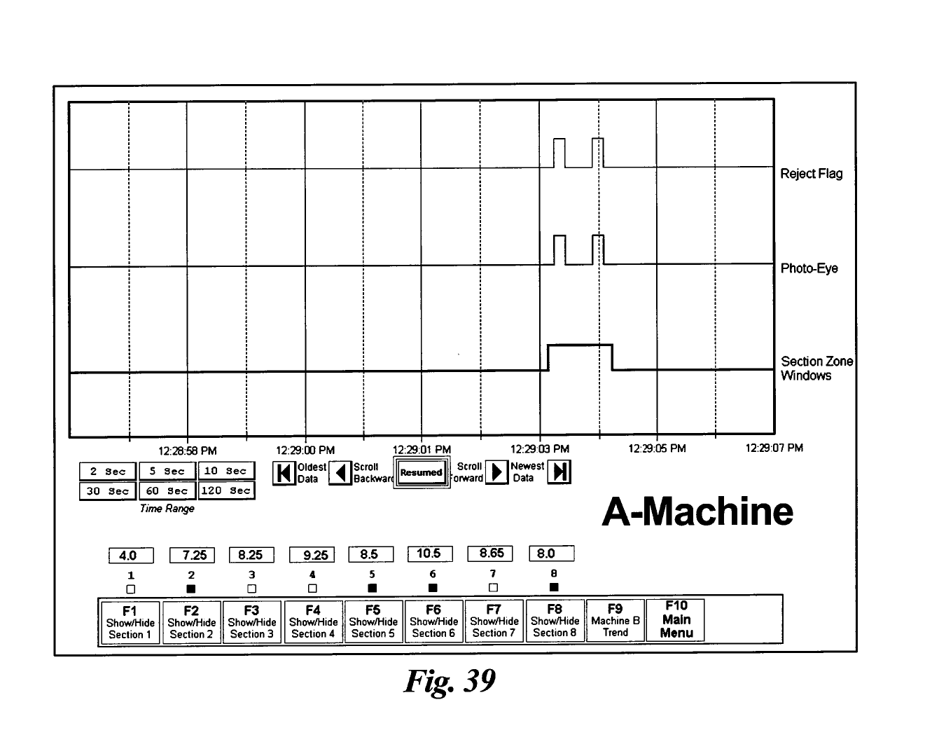

As illustrated in FIG. 39, the HEWR Trend Screen is used to “Fine Tune” a theoretical container “Zone” for each section. This screen shows the Real Time Trend, Reject Flag Pulses, Photo Eye Pulses, Section Zone Windows, Trend Control Buttons, Trend Time Span Buttons, Zone Adjust Numeric Entry Fields, and a Menu Bar for the selected machine.

The Real Time Trend is a graphical strip chart that plots various data points on a scrolling chart. The newest data appears on the right of the trend and scrolls to the left.

The Reject Flag Pulses are present when the container at the photo eye is to be rejected, either by operator action (HEWR switches, Auxiliary Cycle switches, etc.), or due to a Down & Stuck condition.

The Photo Eye Pulses are present when a container is at the photo eye.

The Section Zone Windows pulses represent where in time the Eclipse controller calculates a sections' containers to be. The Photo Eye pulses for a given section's containers should align within the zone window associated with that section. The zone windows for each section are color-coded and can be toggled On or Off to make it easier to see a specific zone or zones.

The Trend Control Buttons allow the real-time trend to be paused and the time span to be scrolled backward and forward.

The Trend Time Span Buttons allow the amount of time displayed in the real-time trend to be changed (2-120 seconds).

Numeric entries (−21 to +21 inches) in the Zone Adjust Numeric Entry fields allow the associated zone window to be adjusted forward or backward to line up with the appropriate container set's Photo-Eye pulses. These values should typically be as close to zero (0) as possible. A large value typically indicates that the “Pusher Start” Event's ON time has been adjusted to accommodate a variation in the Pusher mechanisms' fingers, home position or speed.

The Menu Bar allows toggling the sections' Zone Windows on and off by pressing “F1”-“F8.” Pressing “F9” displays the same screen for the other half of a tandem machine. To return to the “Main Menu,” users press “F10.”

HEWR Setup Guidelines

The following guidelines are intended to assist the Job Setup personnel with setting up the Ware Reject system for optimum performance. In order to have good reject characteristics one should first have good ware handling.

The first step is to make sure that the Eclipse Job Data and Drive system data are both set for the proper ware spacing (e.g., 10.5″) and number of phantom spaces (pockets). Ensure that the Photo-Eye lens is clean and is properly aligned at the bottom of the containers.

Pusher Setup is the most critical step to achieving good ware handling.
1. The pushers must have the proper pusher fingers installed.
2. The pusher fingers must be installed correctly and consistently on the pusher head.
3. The pusher mechanisms must be properly and consistently aligned. This requires properly maintaining the linkage position, Hall sensor locations, and “Home” positions.
4. The pusher's motion profiles (pushout speeds) must be set according to the conveyor speed so that the bottles do not pull away too quickly or wobble. The motion profiles should be consistent on all sections.

Ware Placement on the conveyer is the second most critical step to achieving good ware handling.
1. Start with the section that has the most deadplate time. Leave it where it is on the conveyor. This becomes the “baseline” container position for adjusting the other sections.
2. Next, adjust the “Pushout” ON degrees for the section that follows the baseline section in conveyor order to bring it's containers in behind the baseline section's containers at the proper spacing.
3. Keep working your way down the conveyor order as in step 2, adjusting the pushout out timing of each subsequent set of ware (in conveyor order) to come in behind (or ahead of) the previously adjusted section at the proper spacing.
4. Once all of the sections on one half of the tandem machine have been adjusted, use the same pushout degree numbers achieved, on the other half of the machine.
5. This should give you 2 consistent groupings (A Machine and B Machine) on the conveyor.

Phantom Space(s) on the Conveyor

The use of phantom spaces must first be configured in the Eclipse Job File that was downloaded, and on the Drive system that controls the machine conveyor (flight conveyor). Use the “Machine-B Differential” angle to spread the ware groupings apart or to bring them closer together.

If adjusting the “Machine-B Differential” angle creates the proper phantom spacing, but also causes collision on the other end of the ware groups, the groups on each machine have to be made smaller by adjusting the Pushout Event timing, in order to create the required space on the conveyor.

Adjusting the HEWR

These steps use the “HEWR Parameters” and “HEWR Zone Adjust” screens to achieve proper reject characteristics.
1. Using the real-time trend on the “HEWR Zone Adjust” screen, choose a section to start with whose ware at the photo-eye can easily be visually identified as belonging to that section. This can be done by starting with the section that follows the phantom space(s).
2. Set all Zone Adjusts to zero.
3. Observing the real-time trend screen with the Zone for the chosen section being displayed, pause the trend to observe the relationship with the containers belonging to this section, with the zone window for this section.
4. If the containers are not centered in the zone window, modify the “Downstream Photo-Eye” distance on the “HEWR Parameters” screen until centered.
5. Resume the trend on the “Zone Adjust” screen to allow the new settings to be plotted on the trend.
6. Pause the trend and re-check the relationship between the containers and the zone window.
7. Once the chosen section's ware is centered within its associated zone window, proceed with tuning the other section's zone windows in conveyor order.
8. Using the “HEWR Zone Adjust” screen examine the relationship between each set of ware (Photo-Eye pulses) with the associated section's zone window.
9. Move the zone window (zone adjust entry fields) to center the ware within it.
10. It is OK if the zone windows overlap each other a small amount.
11. Check the reject on the Mold side by activating the HEWR switches.

Cavity Windows

Each zone window is divided into 2 cavity windows for double gob in the PLC program (see FIG. 40(A)). The cavity windows are not displayed on the HEWR Trend screen, as they would create more clutter. For the sake of tuning, just imagine a line dividing each zone window into 2 equal cavities.

When tuning zone windows, the most critical aspect is to center the 2 bottle pulses in the zone window as best you can (see FIG. 40(B)). It is OK if zone windows overlap, however you do not want a bottle to cross the imaginary cavity line (see FIG. 40(C)), as this will cause unwanted rejects.

Zone Windows

With the Zone Windows, it is preferable to have as little or no overlap if possible. However if the Zone windows do overlap as in FIG. 40(D), this is not a problem as the bottle pulses fall within their proper cavity windows. As you can also see in FIG. 40(D), one of the bottle pulses overlaps a little into the other Zone Window. This also is not a problem.

Where there could be a problem with overlapping Zone Windows is when an entire bottle pulse falls within the overlapping area (see FIG. 40(E)). In this case the bottle cannot be rejected, as its zone is not discernable.

### System Status

### System Status Overview

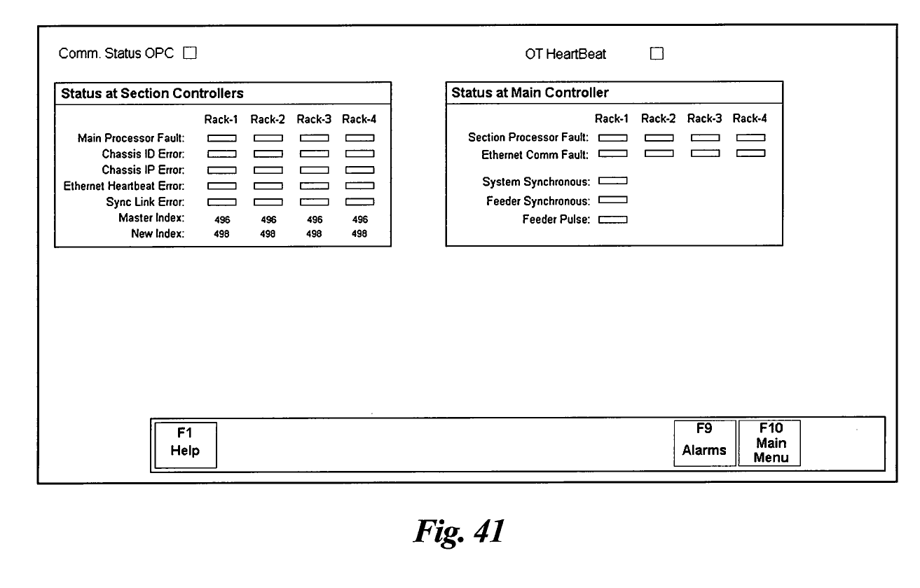

As shown in FIG. 41, the System Status Screen displays the overall communication status of the Eclipse E-Timing control system 100. It includes OT program communications, OT to Eclipse PLC communications, Rack Faults, etc.

The “Status at Section Controllers” panel on the left side of this screen displays various monitored conditions for each of the section controllers (4 sections per controller) in a column.

The indicator is green when the Section Controller is properly communicating with the Main Controller. It turns red when an error occurs.

The Chassis ID Error indicator is green when the Section Controller (chassis) is properly addressed with +24 VDC Inputs on the Input Module: Section Controller #1 (Sections 1-4)=Input #1, Section Controller #2=Input #2, Section Controller #3=Input #3, Section Controller #4=Input #4. It will turn Red if the PLC program detects a different Section Controller number than the hardwired DC Input indicates.

Chassis IP Error

This indicator is Green when the Section Controller's Ethernet Module is properly addressed. The IP addresses for each chassis in this example embodiment are:

| | | | |
|---|---|---|---|
| Main Rack: | 198.70.138.80 | Section 1-4: | 198.70.138.81 |
| Section 5-8: | 198.70.138.82 | Section 9-12: | 198.70.138.83 |
| Section 13-16 | 198.70.138.84 | Section 17-20: | 198.70.138.85 |
| Array Proc.: | 198.70.138.86 | | |

Other IP Addresses:

| | | | |
|---|---|---|---|
| Eclipse OT: | 198.70.138.200 | Eclipse MT: | 198.70.138.201 |

If an Ethernet module is improperly addressed for its location, the indicator will turn Red. The processor recognizes the mismatch and will automatically re-address the Ethernet module for the appropriate address. This is helpful if an Ethernet module fails and requires a replacement, it will automatically define its address.

The Ethernet Heartbeat Error indicator is Green when the Section Controller's Ethernet Module is properly receiving “Heartbeat” pulses from the Main Controller. If not, this indicator will turn Red.

The SYNCHLINK module in each chassis provides a high-speed fiber optic communications channel to the Main Controller. This communication channel is used to synchronize the clocks of each chassis and to provide the Output execution times for the next eight (8) half degree indexes of event timing (Internal Timing Drum). The SYNCHLINK Error Indicator is Green when the Section Controller's SYNCHLINK Module is communicating properly. If not, this indicator will turn Red.

The Master Index and New Index values display the current Master Index value as read from each chassis. The display of these values is not real-time, and as such will be close together in value but not exact. If these values are changing, then everything is OK. If these values stop changing, then the Section Controller is no longer updating its internal Timing Drum. These values are in units of ½ degree and, therefore, are in the range of 0-720.

The “Status at Main Controller” panel on the right side of the System Status Screen displays various monitored conditions for each of the section controllers or racks (4 sections per controller) in a column.

The Section Processor Fault indicator is Green when the Main Controller is properly communicating with the Section Controller. It turns Red when an Error occurs in that communication.

The Ethernet Communication Fault Indicator is Green when the Main Controller's Ethernet Module is properly communicating with the Section Controller's Ethernet Module. The indicator turns red if an Error occurs in that communication link.

The System Synchronous Indicator is Green when the Main Controller detects that all conditions are stable for properly starting and delivering glass to all sections. If a condition is not met, this indicator will turn Red.

The Feeder Synchronous Indicator is Green when the Main Controller detects that the incoming Feeder pulse is stable and present. If an “out of tolerance” change is detected in the frequency of the incoming Feeder Pulses, or if it is missing entirely, this indicator will turn Red.

### Exit Eclipse OT

### Quit Eclipse Dialog Box

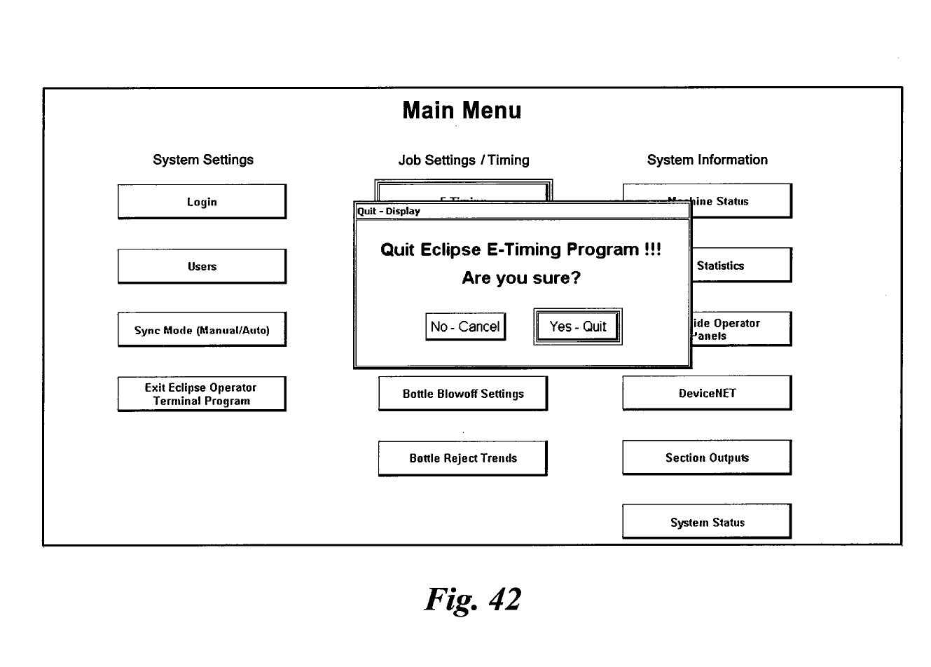

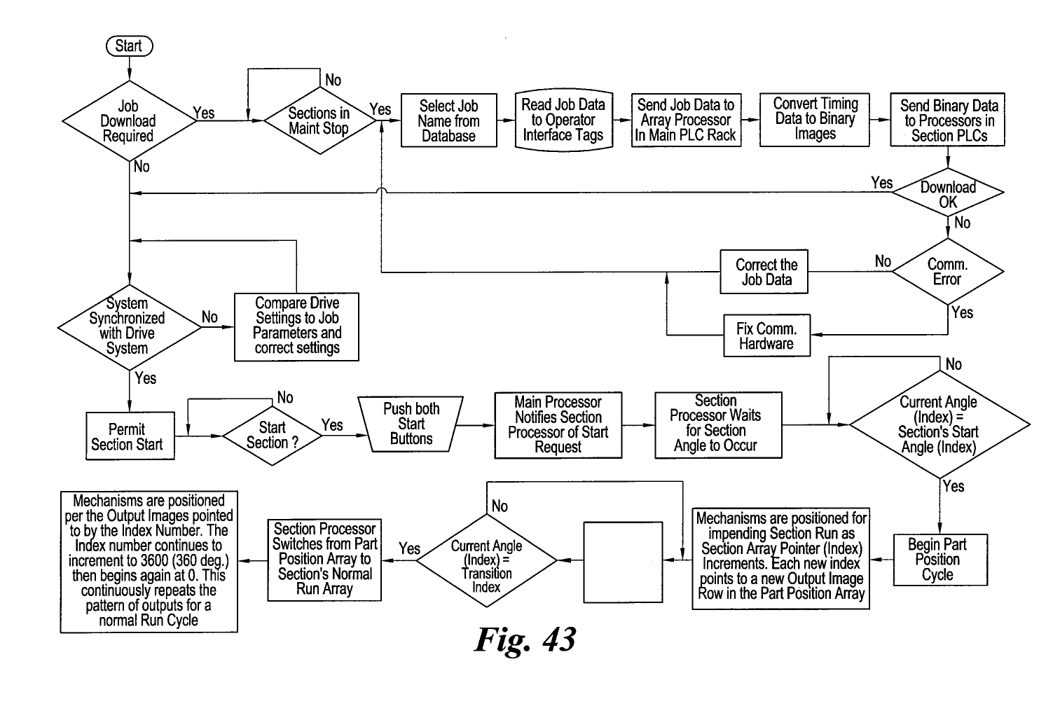

The Main Menu illustrated in FIG. 16 provides access to the “Quit Eclipse E-Timing Program” dialog screen as shown in FIG. 42. When the Main Menu is presented, one can use the “UP ARROW” or “DOWN ARROW” keys until the focus is positioned on the “Exit Eclipse Operator Terminal Program” command button, then press the “ENTER” key to display the dialog box.

This screen has two (2) options available through command buttons. The “No—Cancel” closes the dialog box and allows the operator terminal program to continue running.

The “Yes—Quit” button terminates the operator terminal program.

In various alternative embodiments, the PLC's used in various capacities are replaced by other models, by general purpose microprocessors, or by application-specific integrated circuits (ASIC's). In any of these variations, one or more memory units are associated with each processor or controller to store data and program information as will occur to those skilled in the art. Such memory devices may comprise one or more distinct units of memory, which include one or more types, such as solid-state electronic memory, magnetic memory, or optical memory, just to name a few.

By way of non-limiting example, the memory can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge media; or a combination of these memory types. Also, the memory is volatile, nonvolatile, or a hybrid combination of volatile and nonvolatile varieties.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

While the invention has been illustrated and described in detail in any drawings and the foregoing description, the same is to be considered as illustrative and not restrictive in character, it being understood that only one or more preferred embodiments have been shown and described and that all changes and modifications that come within the spirit of the invention are desired to be protected.

What is claimed is:

1. A glass container production system, comprising
a first glass container forming machine that
accepts control timing input signals and applies them to the mechanical forming of containers, and
outputs glass containers onto a conveyor;
a second glass container forming machine that
accepts control timing input signals and applies them to the mechanical forming of containers, and
outputs glass containers onto the conveyor; and
a control system that includes a PLC and programming instructions executable by the PLC to:
provide control timing input signals to the first machine and to the second machine as a function of job data;
accept changes to the job data from a human user;
responsively to the accepted changes, change the control timing input signals sent to the first machine without interrupting operation of the second machine.

2. The glass container production system of claim 1, wherein:
the control system includes a main controller comprising the PLC; and
each of the first and second machines includes at least one subordinate controller that:
comprises at least one PLC;
receives control timing input signals from the main controller; and
applies the control timing input signals to the mechanical forming of containers without further involvement of the main controller.

3. The glass container production system of claim 2, wherein:
the main controller comprises a master clock; and
each subordinate controller
comprises a timing clock that is synchronized with the master clock; and
applies the control timing input signals as a function of its timing clock.

4. The glass container production system of claim 1, wherein:
sensors in each glass container forming machine detect appearance of a container at a particular location and communicate that appearance to the control system in the form of a photo-eye signal; and
a user interface displays the photo-eye signal in substantially real time.

5. The glass container production system of claim 4, wherein:
the user interface also displays an indicator when a container is expected at the particular location; and
the display of the indicator and the display of the photo-eye signal are synchronized.

6. A system for producing glass containers, comprising a controller and a memory in communication with the controller, the memory being encoded with programming instructions executable by the controller to:
generate output images suitable for interpretation by a first subordinate controller to produce glass containers at a first machine, and by a second subordinate controller to produce glass containers at a second machine; and
simultaneously
provide timing signals to the subordinate controller for production of glass containers at the first machine; and
transmit an output image to the subordinate controller.

7. The system of claim 6, wherein the output images are based on timing calculated in substantially real time as a function of user input.

8. The system of claim 6, wherein the controller, the first subordinate controller, and the second subordinate controller operate on synchronized clocks.

9. The system of claim 8, wherein the controller includes a master clock to which the first and second subordinate controllers are synchronized.

10. The system of claim 9, wherein the synchronization occurs via a fiber optic link.

11. A system for producing glass containers, comprising a controller and a memory in communication with the controller, the memory being encoded with programming instructions executable by the controller to:
generate output images suitable for interpretation by a first subordinate controller to control production of glass containers at a first machine; and
schedule updates of the output image being used by the first subordinate controller based on timing calculated in substantially real time as a function of user input.

12. The system of claim 11, wherein the programming instructions are further executable by the controller to:
generate output images suitable for interpretation by a second subordinate controller to control production of glass containers at a second machine; and
schedule updates of the output image being used by the second subordinate controller based on timing calculated in substantially real time as a function of user input.

13. The system of claim 11, wherein the controller also communicates time synchronization signals with the first subordinate controller.

14. The system of claim 13, wherein the controller further comprises a master clock for the time synchronization signals.

15. The system of claim 14, wherein the synchronization occurs via a fiber optic link.
